(19) United States
(12) Patent Application Publication
(10) Pub. No.: US 2015/0145983 A1
(43) Pub. Date: May 28, 2015

(54) IMAGE ACQUISITION DEVICE, IMAGE ACQUISITION METHOD, AND COMPUTER-READABLE STORAGE MEDIUM

(71) Applicant: CANON KABUSHIKI KAISHA, Tokyo (JP)

(72) Inventors: Kenichi Akashi, Kawasaki-shi (JP); Toru Sasaki, Yokohama-shi (JP)

(21) Appl. No.: 14/552,324

(22) Filed: Nov. 24, 2014

(30) Foreign Application Priority Data
Nov. 28, 2013 (JP) 2013-245900

(51) Int. Cl. G02B 21/36

(52) U.S. Cl. CPC G02B 21/361
USPC 348/80

(57) ABSTRACT

An image acquisition device acquires an image of a subject by capturing images of plural regions of the subject. The image acquisition device includes an image capturing device including an image formation optical unit and an image capturing unit, a temperature measurement unit that measures a temperature of the image capturing device, a selection unit that selects the temperature or an evaluation function by referring to an image of a first region from among the plural regions, the temperature or the evaluation function being selected as reference information for a second region adjacent to the first region, an information acquisition unit that acquires the temperature or the evaluation function, and a control unit that adjusts relative positions of a surface conjugated with a light reception surface of the image capturing unit and the subject, and causes the image capturing unit to capture an image of the second region.

### BACKGROUND

1. Field

Aspects of the present invention generally relate to an image acquisition device, an image acquisition method, and a computer-readable storage medium for a whole slide imaging (WSI) system.

2. Description of the Related Art

To date, in a cancer test and so forth, a pathological diagnosis is made in which a tissue obtained from a patient is mounted on a preparation and observed by using an optical microscope to determine the type and state of a lesion. In contrast, with use of an image acquisition device that captures a digital image of a preparation to acquire the image, a diagnosis can be made on the basis of the image displayed on a display. Accordingly, various merits can be obtained, for example, a remote diagnosis is made quickly, an explanation is given to a patient by using a digital image, and information on rare cases is shared.

In the case of acquiring an image of an entire surface of a subject by using an image acquisition device, images of a plurality of regions of the subject (hereinafter referred to as tile images) captured by a microscope device are acquired, and the tile images are combined to generate a large-region image. However, due to a change in in-focus position (hereinafter referred to as a drift) caused by a change in temperature, an artifact occurs at a boundary between tile images when the tile images are combined. The artifact may be a cause of a decrease in accuracy of diagnosis that is made on the basis of a digital image.

To address such an issue, Japanese Patent No. 04307815 discloses a method of providing, at a certain position on an XY plane of a slide, a region where an in-focus position in an optical axis direction is to be detected, and detecting the in-focus position when a certain condition is satisfied, so as to correct a drift. The in-focus position in the optical axis direction is detected from a profile of an evaluation function of an acquired image. Japanese Patent Laid-Open No. 2011-221294 discloses a method of measuring a temperature of a microscope device and calculating an amount of drift correction on the basis of a difference between the measured temperature and a temperature at a certain timing.

In the method disclosed in Japanese Patent No. 04307815, it is necessary to capture images of a plurality of positions different in an optical axis direction of a certain region, so as to acquire a plurality of pieces of image data (hereinafter referred to as Z-stack image data) in order to acquire a profile of an evaluation function, and thus it takes time to correct a drift. On the other hand, in the method disclosed in Japanese Patent Laid-Open No. 2011-221294, a drift can be corrected at higher speed than in the method of acquiring a profile of an evaluation function, but the accuracy of correction may decrease depending on the rate of change in temperature or the trend of change in temperature, for example, whether the temperature is rising or falling.

### SUMMARY

According to an aspect of the present invention, there is provided an image acquisition device that acquires an image of a subject by capturing images of a plurality of regions of the subject. The image acquisition device includes an image capturing device, a temperature measurement unit, a selection unit, an information acquisition unit, and a control unit. The image capturing device includes an image formation optical unit configured to form an image of the subject and an image capturing unit configured to capture an image of the subject. The temperature measurement unit is configured to measure a temperature of the image capturing device. The selection unit is configured to select the temperature or an evaluation function by referring to an image of a first region from among the plurality of regions, the temperature or the evaluation function being selected as reference information for a second region adjacent to the first region. The information acquisition unit is configured to acquire, as the reference information, the temperature or the evaluation function selected by the selection unit. The control unit is configured to adjust relative positions, in an optical axis direction of the image formation optical unit, of a surface conjugated with a light reception surface of the image capturing unit and the subject in accordance with the reference information acquired by the information acquisition unit, and cause the image capturing unit to capture an image of the second region. The evaluation function is a function representing a relationship between (i) information about a plurality of overlapped-region images that are acquired by capturing images of a plurality of positions different in the optical axis direction in an overlapped region where the first region overlaps the second region, and (ii) the plurality of positions.

Further aspects of the present disclosure will become apparent from the following description of exemplary embodiments with reference to the attached drawings.

### BRIEF DESCRIPTION OF THE DRAWINGS

FIG. 1 is a schematic diagram illustrating the configuration of a WSI system.

FIG. 2 is a block diagram illustrating an image acquisition device.

FIG. 3 is a block diagram illustrating the hardware configuration of an image processing device.

FIGS. 4A to 4E are flowcharts illustrating an image acquisition method according to a first embodiment.

FIGS. 5A to 5C are flowcharts illustrating an image acquisition method according to a second embodiment.

FIG. 6 is an overall view of an image acquisition device according to a third embodiment.

FIGS. 7A to 7E are flowcharts illustrating an image acquisition method according to a third embodiment.

FIGS. 8A to 8D are flowcharts illustrating an image acquisition method according to a fourth embodiment.

FIGS. 9A and 9B are conceptual diagrams illustrating an overlapped region and reference regions.

### DESCRIPTION OF THE EMBODIMENTS

### First Embodiment

An image acquisition device according to a first embodiment will be described. The image acquisition device according to the first embodiment is included in a WSI system.

### Configuration of WSI System

### Overall Configuration

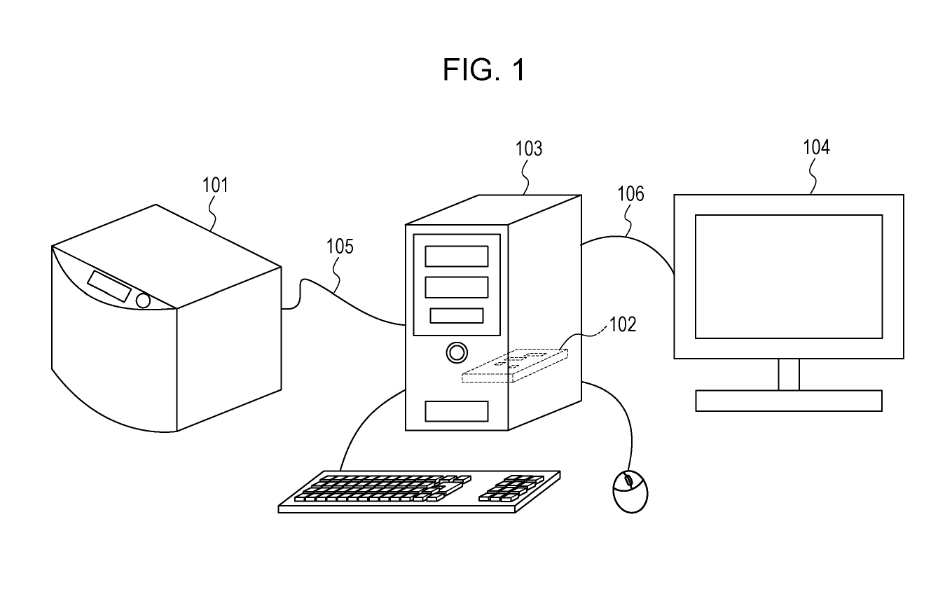

First, a description will be given of the configuration of the WSI system including the image acquisition device according to the first embodiment. FIG. 1 is a schematic diagram illustrating the configuration of the WSI system according to the first embodiment. The WSI system is a system that acquires an optical microscope image of a specimen on a preparation as a subject in the form of a digital image having a high resolution and a large size (wide angle of view).

The WSI system includes an image acquisition device including a microscope device 101 serving as an image capturing device (hereinafter referred to as a “device 101”) and an image processing device 102 (hereinafter referred to as a “device 102”); a computer 103; and a display device 104 (hereinafter referred to as a “device 104”). The device 102 is incorporated as a dedicated processing board into the computer 103. The device 101 and the computer 103 are connected to each other via a cable 105 of a dedicated or general-purpose interface (I/F), and the computer 103 and the device 104 are connected to each other via a cable 106 of a general-purpose I/F.

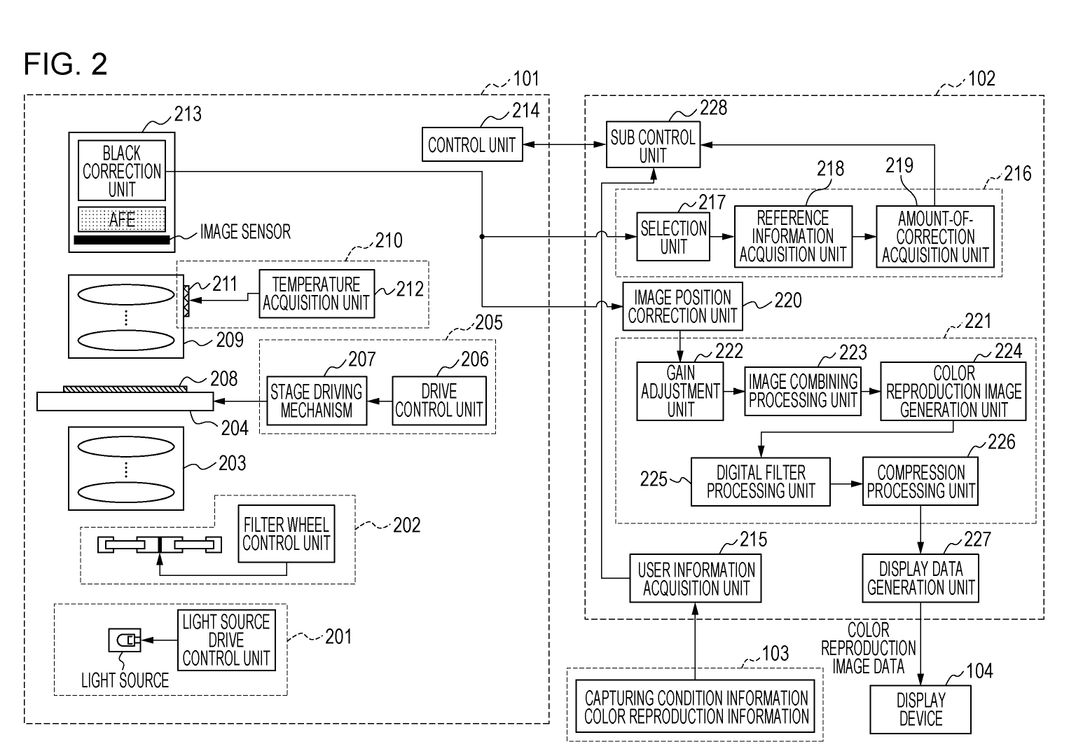

The configurations the individual devices in the WSI system will be described in detail with reference to FIG. 2. First, the configuration of the device 101 serving as an image capturing device will be described. FIG. 2 is a block diagram illustrating the image acquisition device including the devices 101 and 102.

### Microscope Device

The device 101 acquires image data while switching color filters at a plurality of different positions along two axes orthogonal to each other in a plane. The device 101 includes a lighting unit 201, a filter wheel unit 202, a lighting optical unit 203, a stage 204, a stage control unit 205, an image formation optical unit 209, an image capturing unit 213, and a control unit 214. Also, the device 101 according to this embodiment includes a temperature measurement unit 210.

The lighting unit 201 is used, together with the lighting optical unit 203, to evenly irradiate a preparation 208 as a subject placed on the stage 204 with light, and includes a light source and a light source drive control unit.

The filter wheel unit 202 includes a plurality of color filters, a filter wheel for switching the color filters, and a filter wheel control unit for controlling the switching.

The stage 204 is a portion on which the preparation 208 as a subject is to be placed. Drive of the stage 204 is controlled by the stage control unit 205, and accordingly the stage 204 is movable in three axis directions of X, Y, and Z, where an optical axis direction of the image formation optical unit 209 is a Z direction, and the directions orthogonal to the optical axis direction are an X direction and a Y direction.

The preparation 208 is a member obtained by mounting a specimen, such as a slice of a tissue or a smeared cell to be observed, on a glass slide, and fixing the specimen under a glass cover together with a mounting agent.

The stage control unit 205 includes a drive control unit 206 and a stage driving mechanism 207. The drive control unit 206 controls drive of the stage 204 in response to an instruction from the control unit 214. The stage driving mechanism 207 drives the stage 204 in response to an instruction from the drive control unit 206.

The image formation optical unit 209 is a group of lenses for causing an optical image of the preparation 208 to be formed on a light reception surface of an image sensor included in the image capturing unit 213 and thereby forming an image of the subject.

The temperature measurement unit 210 measures a temperature of the device 101, and includes a temperature sensor 211 and a temperature acquisition unit 212. The temperature sensor 211 may be of a contact type, such as a thermocouple, or a noncontact type, such as an optical thermometer.

In this embodiment, the temperature sensor 211 is placed so as to be in contact with the image formation optical unit 209. The temperature sensor 211 may be placed at any other positions related to a change in temperature of the device 101 and a change in in-focus position. The temperature acquisition unit 212 acquires temperature information from the temperature sensor 211. Here, an in-focus position is a position that is optically conjugated with (the image capturing surface of) the image capturing unit 213 via the image formation optical unit 209.

The image capturing unit 213 includes an image sensor, an analog front end (AFE), and a black correction unit, and captures an image of a subject supported by the stage 204. The stage control unit 205 drives the stage 204 in the X and Y directions, and thereby the image capturing unit 213 is capable of capturing images of a plurality of regions of the subject. As a result, a plurality of tile images are acquired (hereinafter referred to as original image data). The image sensor is a two-dimensional image sensor that converts a two-dimensional optical image into an electrical physical quantity through photoelectric conversion. For example, a charge-coupled device (CCD) or a complementary metal-oxide semiconductor (CMOS) device is used as the image sensor. The image sensor outputs an electric signal corresponding to the intensity of light.

The AFE is a circuit for converting an analog signal output from the image sensor into a digital signal. In the case of an image sensor using a CMOS device, the function of the AFE may be integrated with the image sensor.

The black correction unit performs a process of subtracting, from each pixel of image data acquired by the image sensor and the AFE, black correction data acquired when light is blocked.

The control unit 214 controls the above-described units, such as the stage control unit 205 and the image capturing unit 213, by using a control instruction acquired from a sub control unit 228 in the device 102 and information for determining an instruction.

### Image Processing Device

The configuration of the device 102 is now described. The device 102 acquires an amount of correction for an in-focus position on the basis of original image data and temperature information acquired from the device 101, and generates display data to be displayed on the device 104 on the basis of the original image data in response to a request from a user. The device 102 includes a user information acquisition unit 215 (hereinafter referred to as an “acquisition unit 215”), a drift correction unit 216 (hereinafter referred to as a “correction unit 216”), an image position correction unit 220 (hereinafter referred to as a “correction unit 220”), a development processing unit 221 (hereinafter referred to as a “processing unit 221”), a display data generation unit 227 (hereinafter referred to as a “generation unit 227”), and the sub control unit 228.

The correction unit 216 includes a selection unit 217, a reference information acquisition unit 218 (hereinafter referred to as an “acquisition unit 218”) serving as an information acquisition unit, and an amount-of-correction acquisition unit 219 (hereinafter referred to as an “acquisition unit 219”). The processing unit 221 includes a gain adjustment unit 222, an image combining processing unit 223 (hereinafter referred to as a “processing unit 223”), a color reproduction image generation unit 224 (hereinafter referred to as a “processing unit 224”), a digital filter processing unit 225 (hereinafter referred to as a “processing unit 225”), and a compression processing unit 226 (hereinafter referred to as a “processing unit 226”).

The acquisition unit 215 acquires, from a storage device included in the computer 103, capturing condition information for the device 101, color reproduction information used for generating color reproduction image data in the processing unit 221, and so forth. The capturing condition information and the color reproduction information are input in advance by a user via a user interface (UI) or the like, and stored in the storage device.

For example, in a case where a capturing range, which is an example of capturing condition information, is to be input, a reduced image of a preparation is displayed on the device 104, and a user is allowed to specify a capturing range by using a graphical user interface (GUI). Also, as an example of color reproduction information, a user is allowed to select a candidate of an isochromatic function or the like, which is acquired. Among the pieces of information that have been acquired, the capturing condition information is transmitted to the control unit 214 and the processing unit 221 via the sub control unit 228, whereas the color reproduction information is transmitted to the processing unit 221.

The correction unit 216 acquires information necessary to correct a drift and an amount of correction by using the original image data and temperature information acquired by the device 101. In this embodiment, the amount of correction corresponds to an amount of movement in the Z direction of the stage (the optical axis direction of the image formation optical unit 209). A detailed process of a method for correcting a drift will be described below.

The selection unit 217 selects reference information to be used to correct a drift when individual tile images are acquired.

The acquisition unit 218 acquires the reference information selected by the selection unit 217 from the data acquired from the device 101 via the sub control unit 228.

The acquisition unit 219 acquires an amount of drift correction on the basis of the reference information acquired by the acquisition unit 218.

The correction unit 220 corrects displacements in the X and Y directions among a plurality of pieces of original image data acquired from the device 101.

The processing unit 221 generates image data to be displayed on the device 104 by using the original image data acquired by the device 101.

The gain adjustment unit 222 adjusts, in the device 101, the gain of original image data with respect to individual color filters, so as to correct a difference in an amount of exposure.

The processing unit 223 combines the pieces of original image data so as to generate large-region image data as an image of a subject on the basis of the capturing condition information.

The generation unit 224 converts the large-region image data generated by the processing unit 223 into XYZ chromaticity coordinate values. The image data generated through the conversion is referred to as XYZ image data.

The processing unit 225 has a function of a digital filter for suppressing high-frequency components included in the XYZ image data, reducing noise, and emphasizing resolution.

The processing unit 226 performs a process of compressing and encoding a still image, which is performed to enhance the efficiency of transmitting two-dimensional large-region image data such as the XYZ image data, and to reduce the amount of data to be stored. As a method for compressing a still image, standardized coding schemes may be used, for example, Joint Photographic Experts Group (JPEG), and JPEG 2000 or JPEG XR obtained by improving and advancing JPEG. The compressed XYZ image data is transmitted to the storage device of the computer 103 and is stored therein.

The generation unit 227 converts the XYZ image data generated by the processing unit 221 into image data of an RGB color coordinate system that can be displayed on the device 104, by using a lookup table.

The sub control unit 228 is a processing unit that controls the above-described units included in the device 102 and transmits/receives information about control of the device 101 via the control unit 214. Also, the sub control unit 228 automatically judges or determines capturing conditions and so forth by using information input to the acquisition unit 215 or information about capturing stored in the storage unit, if necessary.

### Hardware Configuration of Computer 103

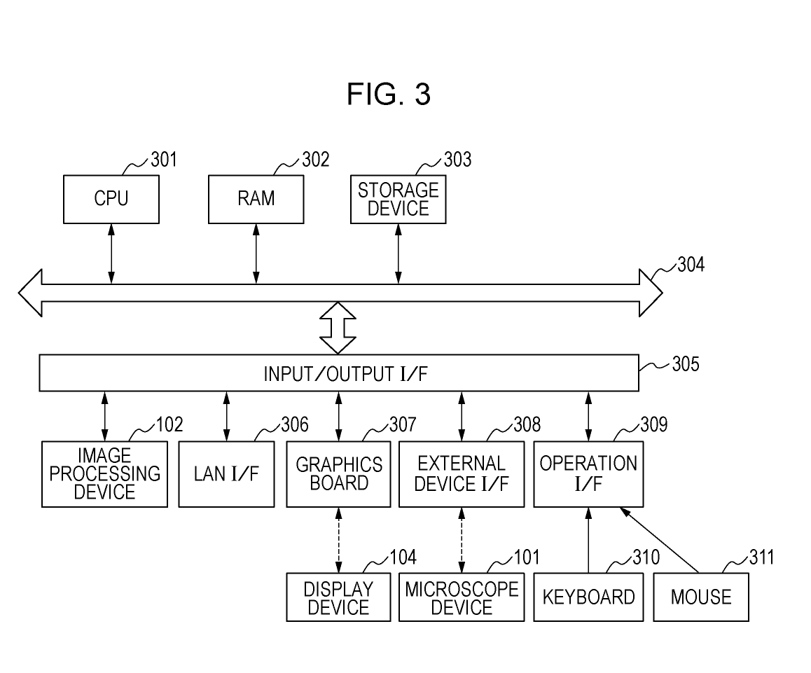

FIG. 3 is a block diagram illustrating the hardware configuration of the computer 103. The computer 103 according to this embodiment is a general personal computer (PC) including the device 102 incorporated thereinto. The device 102 is a dedicated processing board.

The computer 103 includes a central processing unit (CPU) 301, a random access memory (RAM) 302, a storage device 303, a data input/output I/F 305, and an internal bus 304 that connects these devices with one another.

The CPU 301 accesses the RAM 302 and so forth if necessary, and collectively controls the individual blocks of the PC while performing various types of arithmetic processing.

The RAM 302 is used as a working area or the like of the CPU 301, and temporarily stores an operating system (OS), various programs that are being executed, and various pieces of data.

The storage device 303 is an auxiliary storage device which stores the OS to be executed by the CPU 301 and firmware such as programs and various parameters in a fixed manner, in which information is recorded, and from which information is read out. A magnetic disk drive such as hard disk drive (HDD) or a solid state disk (SSD), or a semiconductor device including a flash memory is used as the storage device 303.

The input/output I/F 305 is connected to the device 102 serving as s dedicated processing board, a LAN I/F 306 used for accessing a network, a graphics board 307, an external device I/F 308, and an operation I/F 309. Further, the device 104 is connected to the graphics board 307, the device 101 is connected to the external device I/F 308, and a keyboard 310 and a mouse 311 are connected to the operation I/F 309.

### Display Device

The device 104 displays an image acquired by the device 102, and is a display device using, for example, liquid crystal, electroluminescence (EL), a cathode ray tube (CRT), or the like. As described above regarding the schematic configuration of the WSI system, a notebook PC including the device 104 and the computer 103 integrated together may be used.

As a connection device for the operation I/F 309, a pointing device such as the keyboard 310 or the mouse 311 may be used. Alternatively, the device 104 may have a screen serving as a direct input device, such as a touch panel. In this case, the touch panel may be integrated with the device 104.

### Image Acquisition Process

A brief description will be given of a method for correcting a drift in the image acquisition device including the devices 101 and 102 according to this embodiment. In this embodiment, drift correction is performed when images of a plurality of regions of a subject are captured in order to acquire tile images. Drift correction is performed on the basis of reference information, which is an evaluation function or a temperature of the device 101 at the time when the image capturing unit 213 captures an image of each region.

An evaluation function is a function representing a relationship between (i) information about a plurality of overlapped-region images that are acquired by capturing images of a plurality of positions different in an optical axis direction in an overlapped region where a first region among a plurality of regions of a subject overlaps a second region adjacent to the first region, and (ii) the plurality of positions at the time when the individual overlapped-region images are captured. The function includes an expression expressing a relationship between the information about the plurality of overlapped-region images and the plurality of positions, a table showing a relationship between the information about the plurality of overlapped-region images and the plurality of positions, and so forth. In this specification, also in a case where two regions include a region where the two regions overlap, the two regions are regarded as regions adjacent to each other.

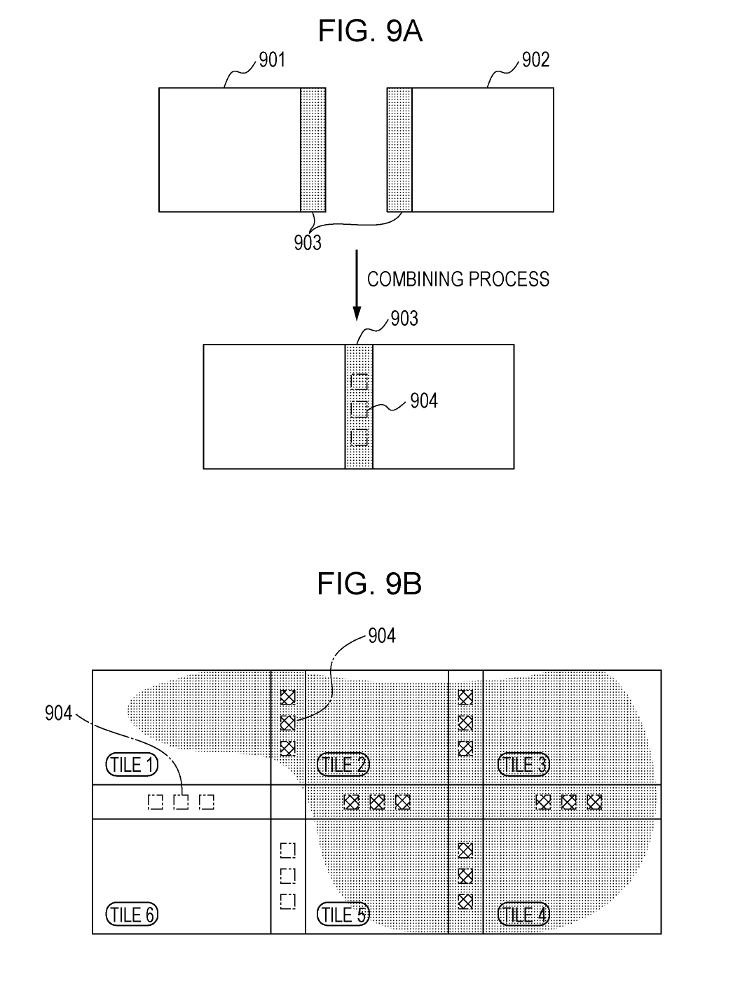

A specific example of the overlapped-region images are images of a certain number of reference regions 904 illustrated in FIG. 9A. The reference regions 904 are located at certain positions in an overlapped region 903 that is generated when a tile image 901 and a tile image 902 are combined. In the description given below, each of a plurality of regions of a subject is referred to as a tile.

FIG. 9B is a schematic diagram illustrating an example of a subject and describing an image acquisition method according to this embodiment. A capturing range of a subject is divided into six tiles, and images of the tiles are captured in order, so that a plurality of tile images are acquired. In FIG. 9B, the tiles are illustrated as tile 1 to tile 6 in accordance with acquisition order.

First, tile 1 as a first region is regarded as a target tile, and tiles 2 and 6 are regarded as a second region adjacent to tile 1. It is detected whether a specimen exists in reference regions, which are part an overlapped region where tile 1 overlaps tiles 2 and 6, and reference information to be used for correcting tiles 2 and 6 is selected in accordance with a detection result. After the reference information has been selected, the tile in the next step (tile 2) is regarded as a target tile, and reference information for tiles adjacent to tile 2 is selected. This operation is repeated to select reference information to be used for drift correction over the entire capturing range.

Drift correction according to this embodiment is performed by adjusting relative positions, in the optical axis direction, of a surface conjugated with a light reception surface of the image capturing unit 213 and a subject when images of individual tiles are captured. Specifically, the relative positions are adjusted by changing the position of the stage 204 on the basis of selected reference information, and image capturing is performed in a state where the relative positions have been adjusted. Accordingly, an image with reduced artifacts can be acquired through drift correction.

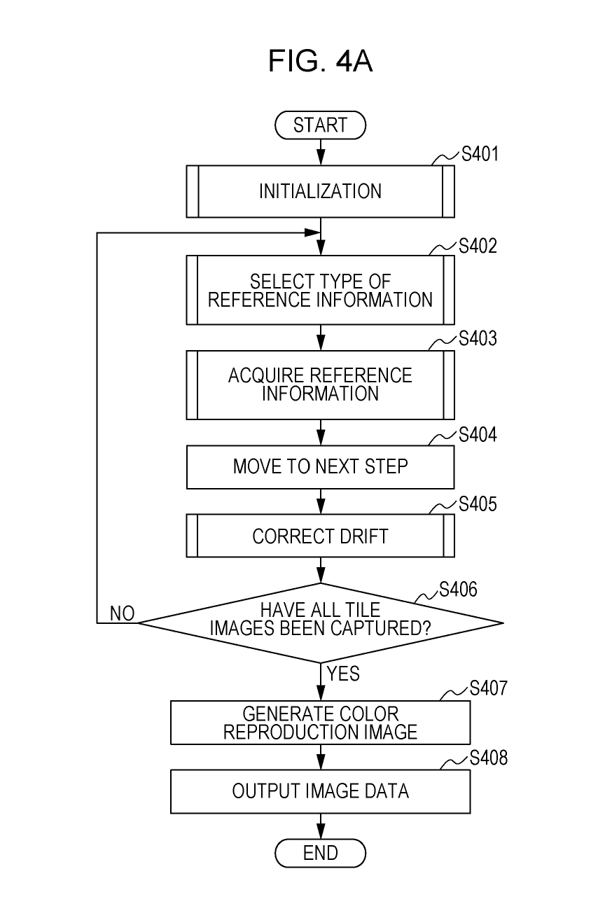

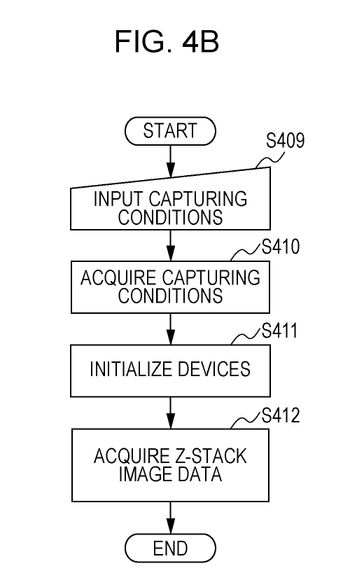

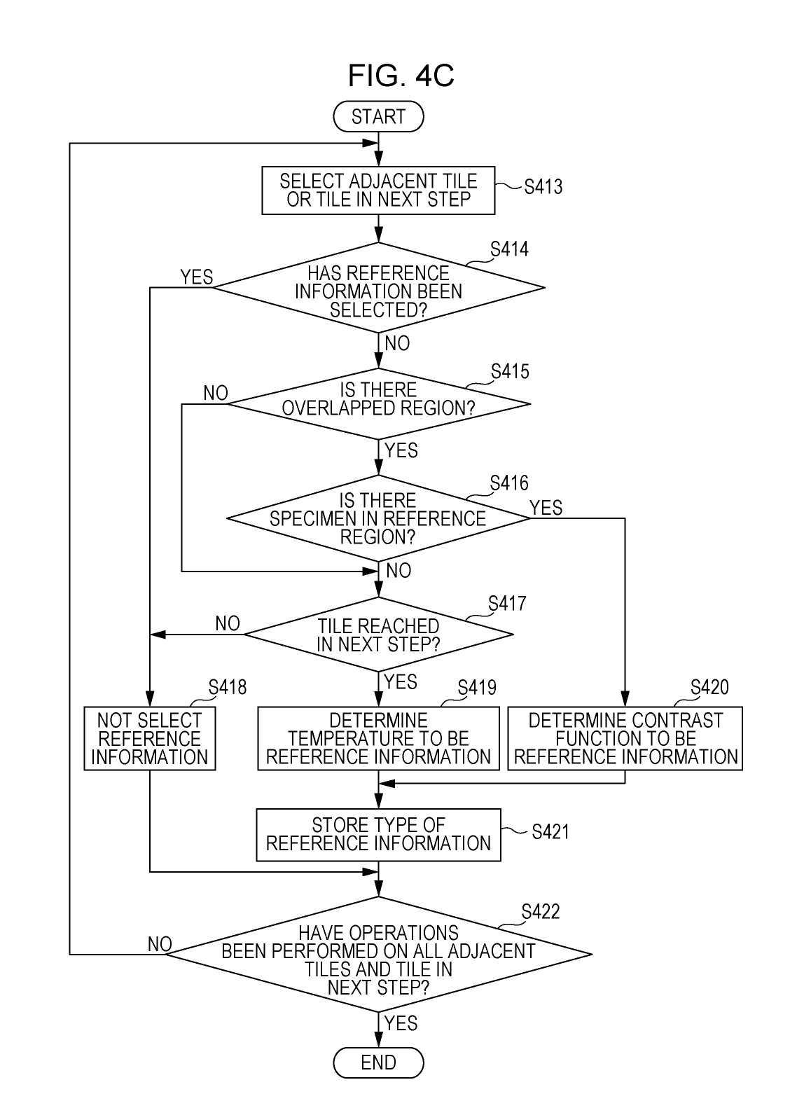

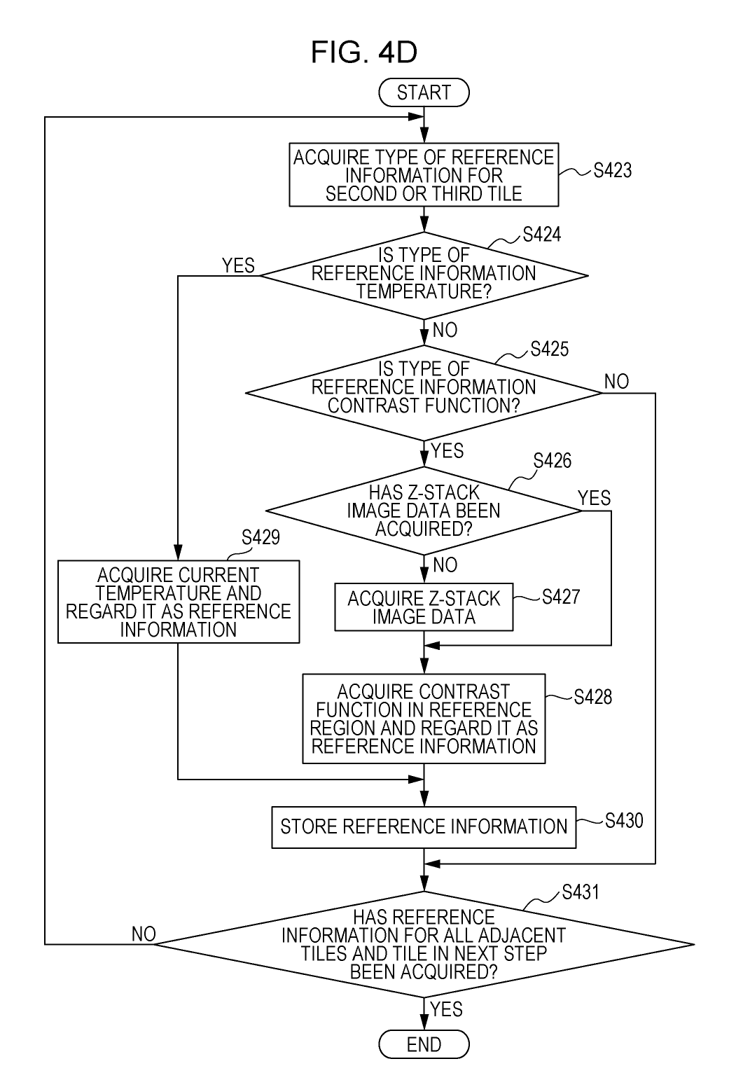

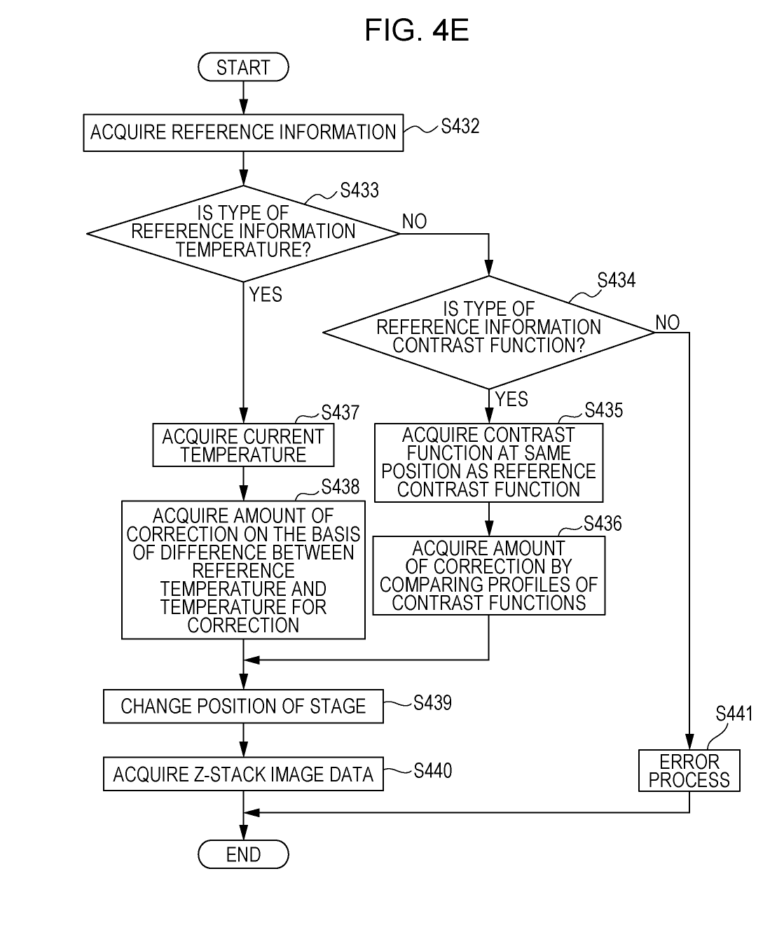

A specific process is now described with reference to the flowcharts illustrated in FIGS. 4A to 4E. In this embodiment and the following embodiments, a contrast function is used as an evaluation function. The contrast function represents a relationship between contrast of a plurality of overlapped-region images and a plurality of positions. The contrast function is acquired by plotting contrast evaluation values in the vertical axis and plotting a plurality of positions in the optical axis direction when individual overlapped-region images are acquired in the horizontal axis.

In step S401, the device 101 is initialized. A process related to initialization of the device 101 is illustrated in the flowchart in FIG. 4B.

In step S409, a user inputs information about capturing conditions, such as a capturing range on the preparation 208, an exposure time of the image sensor, filters to be used for image capturing, and transmission wavebands of the filters, into the device 102 via the computer 103. At this time, color reproduction information such as an isochromatic function is also input if necessary. The input information is once stored in the storage device 303 and is then acquired by the acquisition unit 215.

In step S410, the control unit 214 acquires the information input in step S409 from the acquisition unit 215 via the sub control unit 228.

In step S411, in accordance with the conditions acquired in step S410, the control unit 214 divides the capturing range, calculates a distance over which the stage 204 is to be moved, and determines movement order. At the same time, the control unit 214 initializes the image sensor, stage, light source, and so forth. After that, the stage control unit 205 moves the stage 204 to the first tile image position, so that a tissue in the specimen on the preparation 208 is brought into focus. The focusing process may be performed using an existing method, such as a method for detecting contrast and a method for detecting a phase difference using an external device. Alternatively, the user may manually adjust focus.

In step S412, the image capturing unit 213 captures images at a plurality of positions different in the optical axis direction at the tile image position and focus position adjusted in step S411, and thereby Z-stack image data is acquired. The acquired image data is stored in the storage device 303.

In step S402, reference information to be used for drift correction, which is performed at the time of capturing an image of a second tile (second region) adjacent to a first tile (first region) whose image is captured in the preceding step, or a third tile (third region) whose image is captured immediately after an image of the first tile is captured, is selected. A process related to selection of reference information is illustrated in FIG. 4C. This process is performed by the selection unit 217.

In step S413, a tile (second tile) adjacent to the first tile, which is a tile in the current step, or a tile whose image is captured immediately after the image of the first tile is captured (tile in the next step) is selected. The tile in the next step may be the same as the second tile, or may be different from the second tile, that is, a third tile not adjacent to the first tile.

In step S414, it is judged whether or not reference information for the tile selected in step S413 (hereinafter referred to as a selected tile) has already been selected. If the reference information has already been selected, the process proceeds to step S418. If the reference information has not been selected yet, the process proceeds to step S415.

In step S415, it is judged whether or not an overlapped region exists between the first tile and the selected tile with reference to the tile image of the first tile. If the overlapped region exists, the process proceeds to step S416. If the overlapped region does not exist, the process proceeds to step S417.

In step S416, it is judged whether or not a specimen exists in reference regions between the first tile and the selected tile with reference to the tile image of the first tile. If the specimen exists, the process proceeds to step S420. If the specimen does not exist, the process proceeds to step S417.

In step S417, it is judged whether or not the selected tile is a tile whose image is to be captured next, that is, a tile reached in the next step. If the selected tile is a tile reached in the next step, the process proceeds to step S419. If the selected tile is not a tile reached in the next step, the process proceeds to step S418.

In step S418, it is determined to defer, in the current step, selection of the reference information to be used for drift correction for the selected tile. For the tile for which reference information is not selected in step S418, reference information is selected with reference to an image of a tile captured immediately before the image of the tile is captured or an image of a tile different from the first tile and adjacent to the tile.

In step S419, a temperature is determined to be reference information to be used for drift correction for the selected tile.

In step S420, a profile of a contrast function acquired in the reference regions is determined to be reference information to be used for drift correction for the selected tile.

In step S421, the determination result acquired in step S419 or S420 is stored in the storage device 303.

In step S422, it is judged whether or not steps S413 to S421 have been performed on all the tiles adjacent to the first tile and the tile reached in the next step. If the steps have been performed on all the tiles, the process proceeds to step S403. If the steps have not been performed on all the tiles, the process returns to step S413.

In step S403, the reference information determined in step S402 is acquired from the image of the first tile.

A process related to acquisition of the reference information is illustrated in FIG. 4D. Among the steps included in this process, the steps except steps S427 and S404 are performed by the acquisition unit 218.

In step S423, the type of reference information for the second tile or the third tile, selected in step S402, is acquired from the storage device 303.

In step S424, it is judged whether or not the type of reference information acquired in step S423 is a temperature. If the type of reference information is a temperature, the process proceeds to step S429. If the type of reference information is not a temperature, the process proceeds to step S425.

In step S425, it is judged whether or not the type of reference information acquired in step S423 is a contrast function. If the type of reference information is a contrast function, the process proceeds to step S426. If the type of reference information is not a contrast function, the process proceeds to step S431.

In step S426, it is judged whether or not Z-stack image data for the tile image of the first tile has been acquired. If the Z-stack image data has been acquired, the process proceeds to step S428. If the Z-stack image data has not been acquired, the process proceeds to step S427.

In step S427, the image capturing unit 213 acquires Z-stack image data for the first tile. The acquired Z-stack image data is stored in the storage device 303.

In step S428, a contrast function is acquired using an image of an overlapped region (overlapped-region image) in the Z-stack image data for the first tile. Specifically, a profile of a contrast function is acquired from a plurality of reference region images in the Z-stack image data captured by the image capturing unit 213 (hereinafter such a contrast function is referred to as a reference contrast function), and the profile of the contrast function is regarded as reference information for the selected tile.

In step S429, a temperature of the device 101 (hereinafter referred to as a reference temperature) is acquired, which is regarded as reference information for the selected tile.

In step S430, the reference information acquired in step S428 or S429 is stored in the storage device 303. At the same tile, the reference information is recorded in a header portion of the Z-stack image data acquired for the first tile.

In step S431, it is judged whether or not reference information for all the adjacent tiles and the tile reached in the next step has been acquired. If the reference information has been acquired, the process proceeds to step S404. If the reference information has not been acquired, the process returns to step S423.

In step S404, the stage control unit 205 drives the stage 204 to move to the tile whose image is to be captured next.

In step S405, drift correction is performed on the basis of the reference information determined in step S402. A process related to drift correction is illustrated in FIG. 4E. The steps included in this process are performed by the acquisition unit 218 and the acquisition unit 219.

In step S432, the reference information determined in step S402 is acquired from the storage device 303 or the header portion of the Z-stack image data acquired for the tile for which the reference information has been determined.

In step S433, it is judged whether or not the type of the reference information acquired in step S432 is a temperature. If the type of the reference information is a temperature, the process proceeds to step S437. If the type of the reference information is not a temperature, the process proceeds to step S434.

In step S434, it is judged whether or not the type of the reference information acquired in step S432 is a contrast function. If the type of the reference information is a contrast function, the process proceeds to step S435. If the type of the reference information is not a contrast function, the process proceeds to step S441.

In step S435, the acquisition unit 218 acquires a profile of a contrast function in a reference region including a region having a feature that is at least partially the same as the reference region for which a reference contrast function is acquired in step S403 (hereinafter such a contrast function is referred to as a contrast function for correction).

In step S436, the acquisition unit 219 compares the profile of the reference contrast function with the profile of the contrast function for correction, so as to acquire an amount of correction at a position in the optical axis direction.

In step S437, the acquisition unit 218 acquires a current device temperature (temperature for correction).

In step S438, the acquisition unit 219 acquires an amount of correction at the position in the optical axis direction of the stage 204 on the basis of a difference between the reference temperature and the temperature for correction.

In step S439, the stage control unit 205 changes the position of the stage 204 on the basis of the amount of correction acquired in step S436 or S438.

In step S440, the image capturing unit 213 acquires Z-stack image data in the tile image in the current step. The acquired Z-stack image data is stored in the storage device 303.

In step S441, a message is displayed on the device 104 or the like so as to notify the user that an error has occurred in the drift correction process.

In step S406, it is judged whether or not all the tile images in the capturing range determined in step S401 have been acquired. If all the tile images have been acquired, the process proceeds to step S407. If all the tile images have not been acquired, the process returns to step S402.

The following steps are performed by the correction unit 220, the processing unit 221, and the generation unit 227.

In step S407, the correction unit 220 first acquires the Z-stack image data of each tile from the storage device 303. Subsequently, the correction unit 220 corrects displacements in the X and Y directions among the tile images for the acquired Z-stack image data, by using an existing method such as a corner detection method (Harris method or the like) or a speeded up robust features (SURF) method. The gain adjustment unit 222 performs gain adjustment on the Z-stack image data for which displacements have been corrected.

Subsequently, pieces of image data that have been subjected to gain adjustment are combined by the processing unit 223. On the basis of Z-stack image data of a large size generated through the combining, the generation unit 224 generates a color reproduction image. The color reproduction image is generated on the basis of the color reproduction information input by the user in step S401 or the color reproduction information stored in the storage device 303 in advance. Further, the processing unit 225 performs a process to generate color reproduction image data.

In step S408, the color reproduction image data generated in step S407 is compressed by the processing unit 226 and is transmitted to the storage device 303. Subsequently, the generation unit 227 generates display data and outputs it to the device 104. The processes performed by the processing unit 226 and the display data processing unit 227 may be simultaneously performed in parallel.

As described above, in this embodiment, selection of reference information for a tile (second tile) adjacent to a tile (first tile) whose image has been captured is repeated, so as to acquire reference information for each tile. Reference information is selected by judging whether or not a specimen exists in a reference region by referring to the image of the first tile, and thereby switching between highly accurate correction using a profile of an evaluation function and high-rate correction based on a difference in temperature is performed, and thus an image with reduced artifacts can be efficiently acquired.

In the drift correction process according to this embodiment, correction using a profile of an evaluation function is capable of suppressing a decrease in accuracy caused by accumulated correction errors, because reference information in a previous step is used. Also, correction based on a difference in temperature is capable of suppressing a decrease in correction accuracy caused by a large change in temperature because reference information in the latest step is used.

In this embodiment, reference information for a tile (second tile) adjacent to the first tile and a tile in the next step whose image is captured immediately after the image of the first tile is captured is selected and acquired. As a derivation thereof, in the case of basically capturing an image of a tile adjacent to the tile in the current step in the next step, reference information for only the tile in the next step may be selected and acquired, and only the tile in the next step may be corrected. With this method, the number of steps of judging the type of reference information can be reduced. Specifically, steps S414, S417, S418, and S422 are not necessary. Therefore, drift correction can be performed at a higher rate.

### Second Embodiment

The configuration of a WSI system according to a second embodiment is similar to that in the first embodiment, and thus the description thereof is omitted.

A brief description will be given of drift correction performed in the devices 101 and 102 according to this embodiment. In this embodiment, as in the first embodiment, drift correction is performed before images of individual tiles are captured. However, this embodiment is different from the first embodiment in that two modes are installed for correction.

One of the two modes is a change-in-temperature monitoring mode in which change in temperature of the device 101 is monitored and switching between drift correction based on a profile of an evaluation function and drift correction based on a temperature is performed in accordance with the state of change in temperature. The number of steps in which drift correction is performed using a temperature as reference information (the number of temperature-dependent steps) is set in accordance with a relationship between the temperature of the device 101 and a drift held as a data table. Alternatively, the number of steps may be set by calculating the number of steps in which an amount of drift, which is estimated from an amount of change in temperature per unit time and increase/decrease in temperature (trend of change in temperature), is within a certain range.

The other mode is a specific step temperature correction mode in which drift correction is performed at a high rate on the basis of a difference in temperature without acquiring a profile of an evaluation function during a certain step (specific step).

In addition to the above-described two modes, there is newly provided a function of temporarily deferring drift correction in a case where a specimen does not exist in a reference region continuously during a certain step (hereinafter referred to as a skip and return correction function). This is also a difference from the first embodiment. Specifically, drift correction is temporarily deferred, and steps proceed until a tile that can be corrected on the basis of an evaluation function appears. After correction has been completed for the tile that can be corrected on the basis of an evaluation function, the steps return to correct the tile for which correction has been deferred.

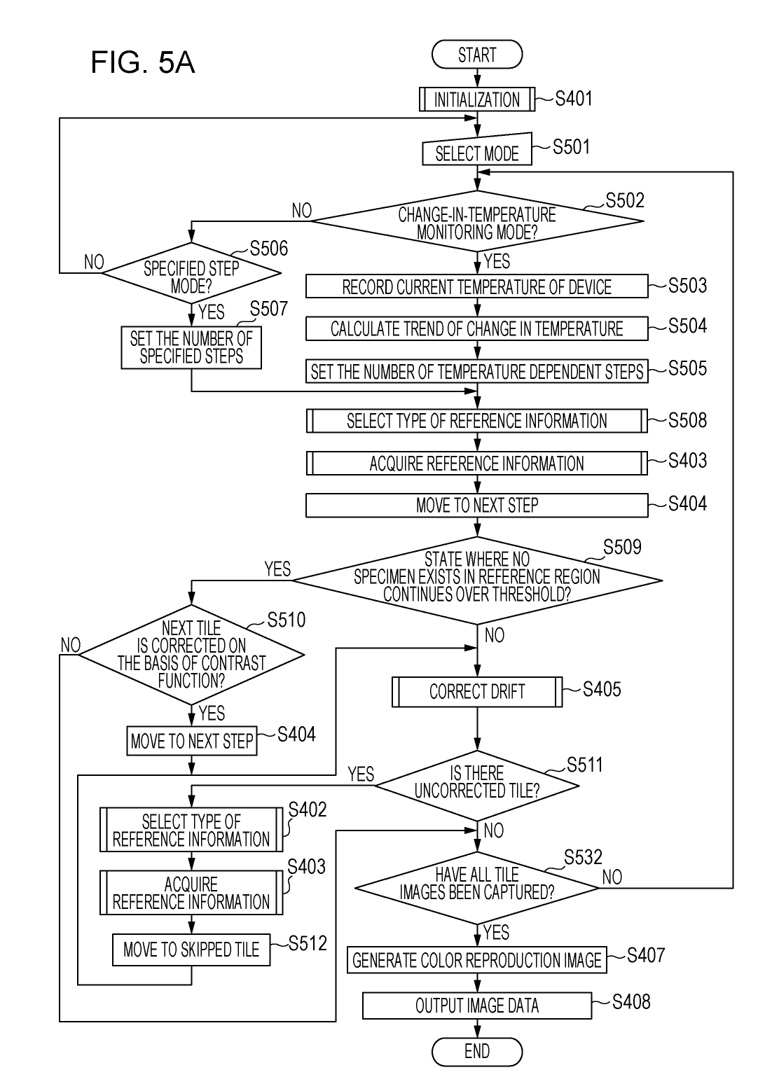

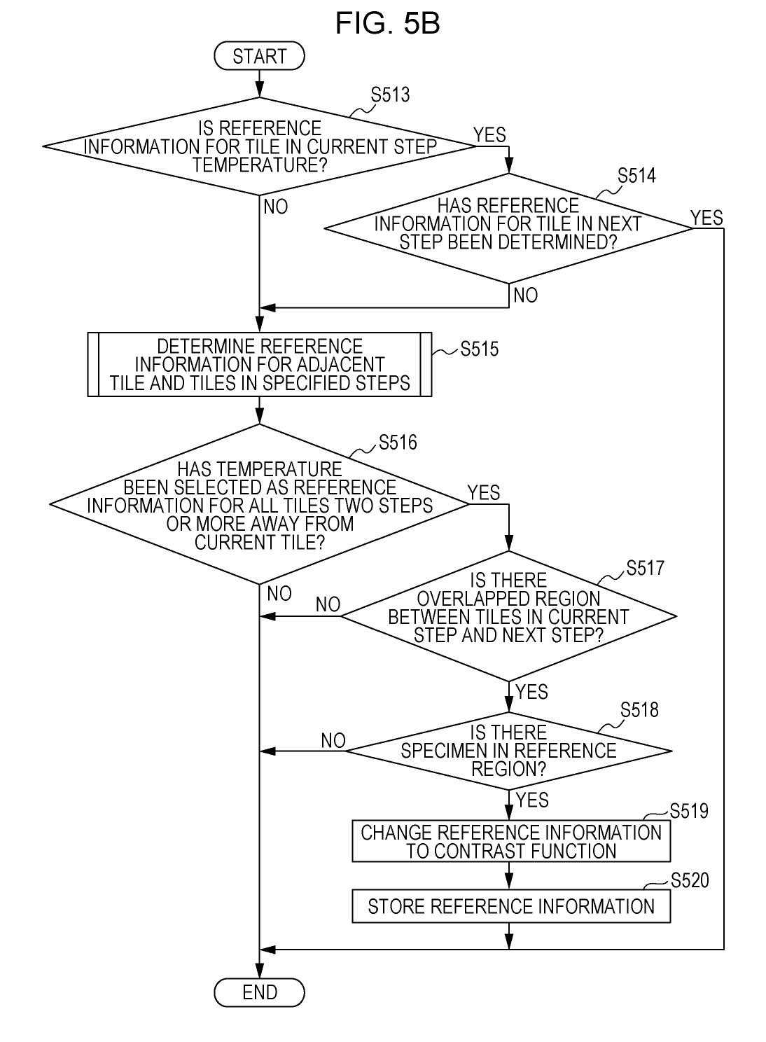

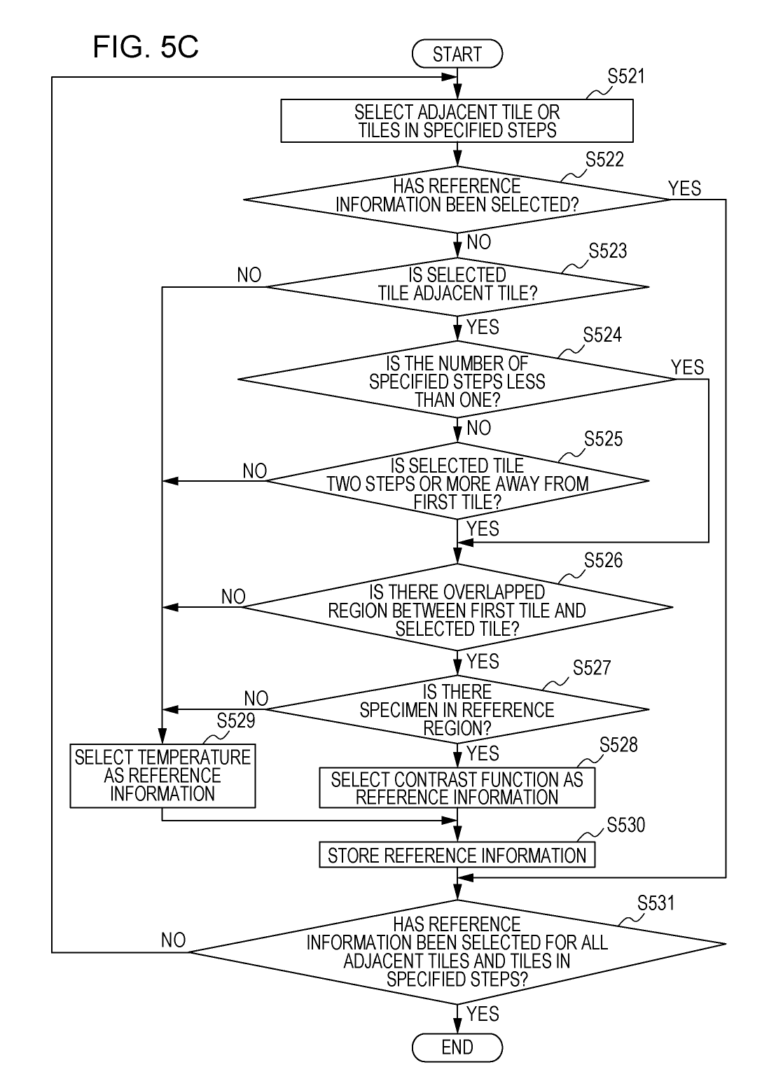

A specific process is now described using the flowcharts illustrated in FIGS. 5A to 5C. Step S401 is similar to that in the first embodiment, and thus the description thereof is omitted.

In step S501, a user inputs a mode of drift correction into the device 102 via the computer 103. If necessary, the user also inputs the number of specific steps to be used in the specific step temperature correction mode. Also, the user inputs, as a threshold for executing the skip and return correction function, the number of steps in which a state where no specimen exists in a reference region continues. The number of specific steps and the threshold for executing the skip and return correction function may be automatically determined by the sub control unit 228 or the computer 103 in accordance with the capturing conditions input in step S401, a history of past usage, and so forth.

In step S502, it is judged whether or not the drift correction mode input in step S501 is the change-in-temperature monitoring mode. If the drift correction mode is the change-in-temperature monitoring mode, the process proceeds to step S503. Otherwise, the process proceeds to step S506.

In step S503, the current temperature of the device 101 is acquired from the temperature measurement unit 210. Temperature information representing the acquired temperature is stored in the storage device 303. In step S504, the temperature information is acquired from the storage device 303, and a trend of change in temperature is calculated. In step S505, the number of temperature-dependent steps is set on the basis of the calculation result of the trend of change in temperature acquired in step S504.

In step S506, it is judged whether or not the drift correction mode input in step S501 is the specific step mode. It the drift correction mode is the specific step mode, the process proceeds to step S507. Otherwise, the process returns to step S501.

In step S507, the number of specific steps input in step S501 is set. The above-described steps S502 to S507 are performed by the sub control unit 228.

In step S508, reference information to be used for drift correction is selected. A process related to selection of reference information in step S508 is illustrated in FIG. 5B. This process is performed by the selection unit 217.

In step S513, it is judged whether or not reference information for the tile in the current step (first tile) is a temperature. If the reference information is a temperature, the process proceeds to step S514. If the reference information has not been determined yet or is something other than a temperature, the process proceeds to step S515.

In step S514, it is judged whether or not reference information to be used for drift correction for the tile whose image is captured immediately after the image of the first tile is captured (the tile in the next step) has already been determined. If the reference information has already been determined, the process proceeds to step S403. If the reference information has not been determined, the process proceeds to step S515.

In step S515, reference information for a tile adjacent to the first tile (second tile) and for tiles in the temperature-dependent steps or the specific steps determined in step S505 or S507 is determined.

A process related to determination of reference information in step S515 is illustrated in FIG. 5C. This process is performed by the selection unit 217.

In step S521, the tile adjacent to the tile in the current step or the tiles in the specific steps is selected.

In step S522, it is judged whether or not reference information for the tile selected in step S521 (selected tile) has already been determined. If the reference information has been determined, the process proceeds to step S531. If the reference information has not been determined, the process proceeds to step S523.

In step S523, it is judged whether or not the selected tile is a tile adjacent to the first tile. If the selected tile is the adjacent tile, the process proceeds to step S524. If the selected tile is not the adjacent tile, the process proceeds to step S529.

In step S524, it is judged whether or not the number of temperature-dependent steps or the number of specific steps set in step S505 or S507 is less than 1 when viewed from the first tile. If the number is less than 1, the process proceeds to step S526. If the number is not less than 1, the process proceeds to step S525.

In step S525, it is judged whether or not the selected tile is two steps or more away from the first tile. If the selected tile is two steps or more away from the first tile, the process proceeds to step S526. Otherwise, the process proceeds to step S529.

In step S526, it is judged whether or not an overlapped region exists between the first tile and the selected tile with reference to the image of the first tile. If the overlapped region exists, the process proceeds to step S527. If the overlapped region does not exist, the process proceeds to step S529.

In step S527, it is judged whether or not a specimen exists in a reference region between the tile in the current step and the selected tile. If the specimen exists, the process proceeds to step S528. If the specimen does not exist, the process proceeds to step S529.

In step S528, a profile of a contrast function is selected as reference information for the selected tile.

In step S529, a temperature is selected as reference information for the selected tile.

In step S530, the reference information selected in step S528 or S529 is stored in the storage device 303.

In step S531, it is judged whether or not reference information has been selected for all the tiles adjacent to the tile in the current step and the tiles in the temperature-dependent steps or the specified steps. If the reference information has been selected, the process proceeds to step S516. If the reference information has not been selected, the process proceeds to step S521.

In step S516, it is judged whether or not a temperature has been selected as reference information for all the tiles two steps or more away from the tile in the current step. If a temperature has been selected as reference information for all the target tiles, the process proceeds to step S517. Otherwise, the process proceeds to step S403.

In step S517, it is judged whether or not an overlapped region exists between the tile in the current step and the tile in the next step. If the overlapped region exists, the process proceeds to step S518. If the overlapped region does not exist, the process proceeds to step S403.

In step S518, it is judged whether or not a specimen exists in a reference region between the tile in the current step and the tile in the next step. If the specimen exists, the process proceeds to step S519. If the specimen does not exist, the process proceeds to step S403.

In step S519, the reference information for the tile in the next step viewed from the tile in the current step is changed to a profile of a contrast function.

In step S520, the reference information is stored in the storage device 303 on the basis of the result acquired in step S519. Subsequently, the process proceeds to step S403 in FIG. 5A. Steps S403 and S404 are similar to those in the first embodiment, and thus the description thereof is omitted.

In step S509, the sub control unit 228 or the computer 103 judges whether or not a state where a specimen does not exist in a reference region continues beyond the threshold for executing the skip and return correction function determined in step S501. If such a state continues, the process proceeds to step S510. If such a state does not continue, the process proceeds to step S405.

In step S510, it is judged whether or not the tile in the next step viewed from the tile in the current step is corrected on the basis of a profile of a contrast function. If the reference information is a profile of a contrast function, the process proceeds to step S404. If the reference information is not a profile of a contrast function, the process proceeds to step S532.

After step S404, the process proceeds to step S511 via step S405. Steps S404 and S405 are similar to those in the first embodiment, and thus the description thereof is omitted. In step S511, it is judged whether or not a tile for which correction has been skipped and has not been corrected exists due to steps S509 and S510. If a tile that has not been corrected exists, the process proceeds to step S402. If a tile that has not been corrected does not exist, the process proceeds to step S532.

After the process proceeds from step S511 to step S402, the process proceeds to step S512 via steps S402 and S403. Steps S402 and S403 are similar to those in the first embodiment, and thus the description thereof is omitted. In step S512, the stage control unit 205 moves the stage 204 to the position of the tile for which correction has been skipped.

In step S532, it is judged whether or not images of all the tiles in the capturing range determined in step S401 have been captured and the tile images have been acquired. If the tile images have been captured, the process proceeds to step S407. If the tile images have not been captured, the process proceeds to step S502.

Steps S407 and S408 are similar to those in the first embodiment, and thus the description thereof is omitted.

As described above, in this embodiment, reference information for a tile (second tile) adjacent to a tile (first tile) in each step is selected by referring to the image of the first tile, so that reference information is acquired for each tile in each step. As a result of selecting reference information by judging whether or not a specimen exists in a reference region by referring to the image of the first tile, switching between highly accurate correction using a profile of an evaluation function and a high-rate correction based on a difference in temperature is performed, and accordingly an image with reduced artifacts can be efficiently acquired.

Further, in this embodiment, the change-in-temperature monitoring mode and the specific step temperature correction mode are provided for correction, and also the skip and return correction function is provided. In the change-in-temperature monitoring mode, a contrast function or a temperature is selected as reference information to be used for drift correction in accordance with a trend of change in temperature, and thereby both of high positioning accuracy and a high correction rate can be realized. In the specific step temperature correction mode, a profile of a contrast function is not acquired for certain steps, and accordingly drift correction at a higher rate can be realized.

Further, with the skip and return correction function, drift correction is deferred for a tile in which a specimen does not exist in a reference region, and correction is performed returning from a tile for which drift correction based on a contrast function is performed. As a result, accumulation of drift correction errors, which are caused by continuously performed drift correction using a temperature as reference information for many steps, can be reduced.

With the above-described two modes and the skip and return correction function, high positioning accuracy, high-rate correction, and reduction of accumulation of drift correction errors can be realized, and effective correction can be performed in which both the accuracy of drift correction and the rate necessary for acquiring an image are obtained.

### Third Embodiment

### Configuration of WSI System

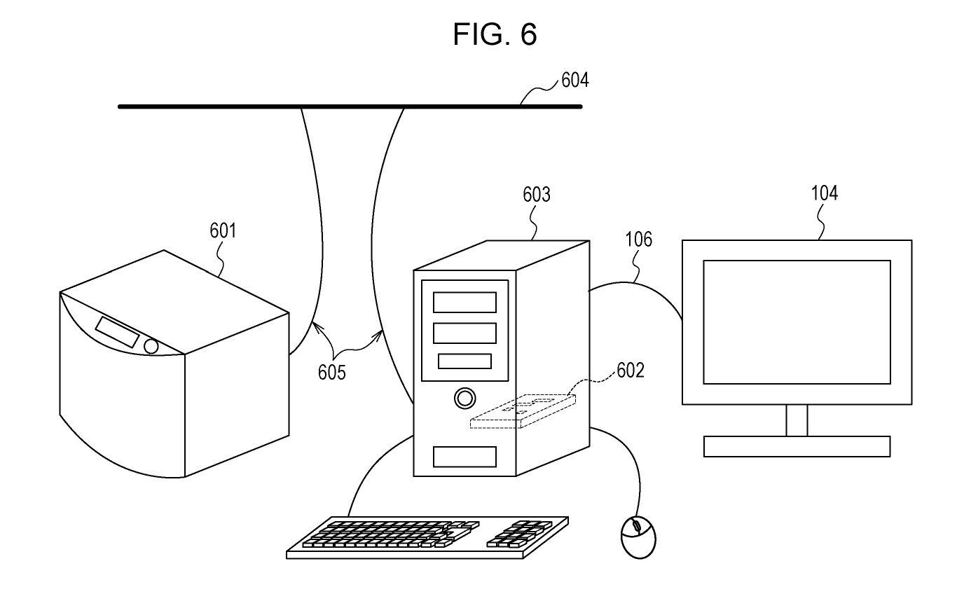

FIG. 6 is a schematic diagram illustrating a schematic configuration of a WSI system according to a third embodiment. This slide scanner system includes an image acquisition device including a microscope device 601 (hereinafter referred to as a “device 601”) serving as an image capturing device and an image processing device 602 (hereinafter referred to as a “device 602”). The device 602, which is a dedicated processing board, is included in a computer 603, and the device 601 and the computer 603 are connected to each other via a network. This system has a configuration for acquiring a microscope image of a specimen on a preparation, which is a subject, as a digital image of high resolution and a large size (wide angle of view).

The WSI system includes the image acquisition device including the device 601 as an image capturing device and the device 602, the computer 603, and the device 104. The device 601 and the computer 603 are connected to each other by dedicated or general-purpose I/F LAN cables 605 via a network 604. The computer 603 and the device 104 are connected to each other via a general-purpose I/F cable 106.

The device 601 has a configuration similar to that of the device 101 according to the first embodiment, but is different in being provided with a LAN I/F for network connection.

The configurations of the device 602 and the device 104 are similar to those in the first embodiment. The hardware configuration of the computer 603 is similar to that in the first embodiment, but is different in being connected to the device 601 via the LAN I/F and the network.

### Image Acquisition Process

A brief description will be given of drift correction performed in the image acquisition device according to this embodiment. In this embodiment, the image capturing unit 213 captures images of an entire capturing range, which is a specimen region, at positions different in the thickness direction of the specimen (the optical axis direction of the image formation optical unit), so as to acquire premap image data. Subsequently, as in the first embodiment, the capturing range is divided into a plurality of tiles, and Z-stack image data is acquired for each tile.

Here, each of the premap image data and the Z-stack image data includes a plurality of pieces of image data that are captured at a plurality of positions different in the optical axis direction. The positions of the plurality of pieces of image data in the optical axis direction are referred to as pieces of height information of the individual pieces of image data.

In this embodiment, acquired tile images are associated with the respective positions in the X and Y directions on the premap, and drift correction is performed using height information of premap image data and height information of individual pieces of image data of Z-stack image data of each tile.

Specifically, a certain tile image (hereinafter referred to as an image of a first tile) is regarded as a target, and reference information for a second tile adjacent to the first tile is selected with reference to the image of the first tile. A process of selecting reference information is similar to that in the first embodiment. However, it is different from the first embodiment in that reference information is acquired on the basis of an image of a region corresponding to the first tile in a premap image, and that drift correction is performed using height information of Z-stack image data, instead of changing the position of the stage.

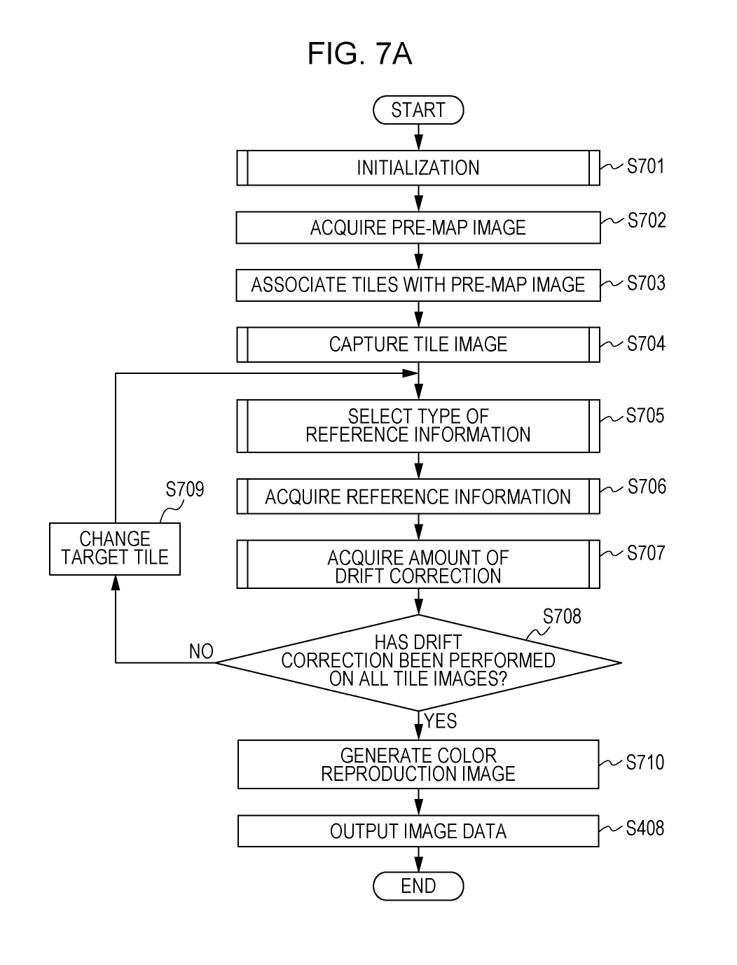

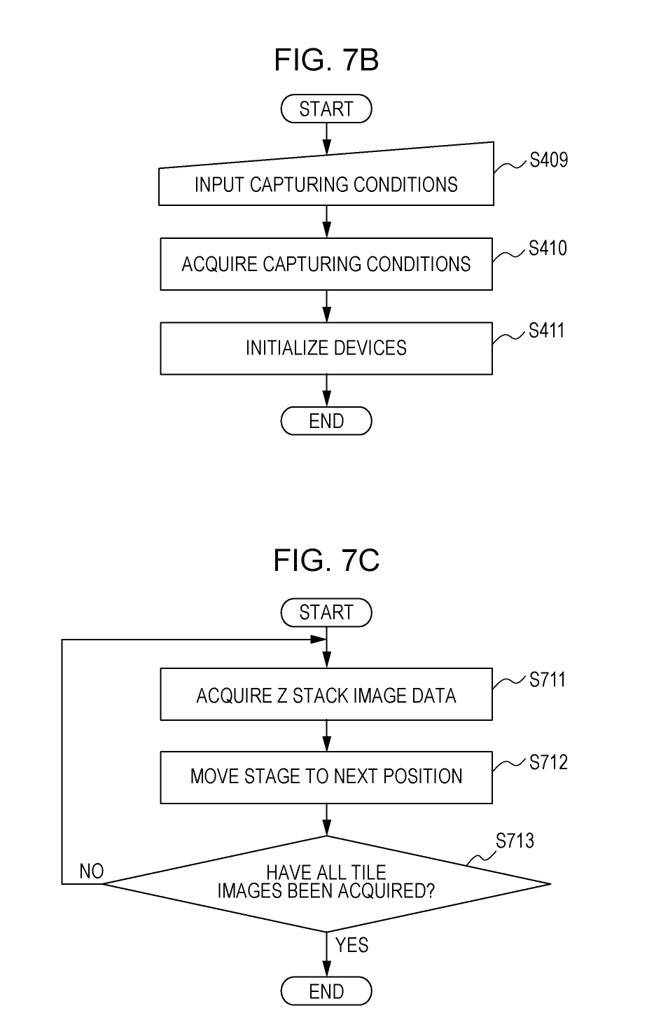

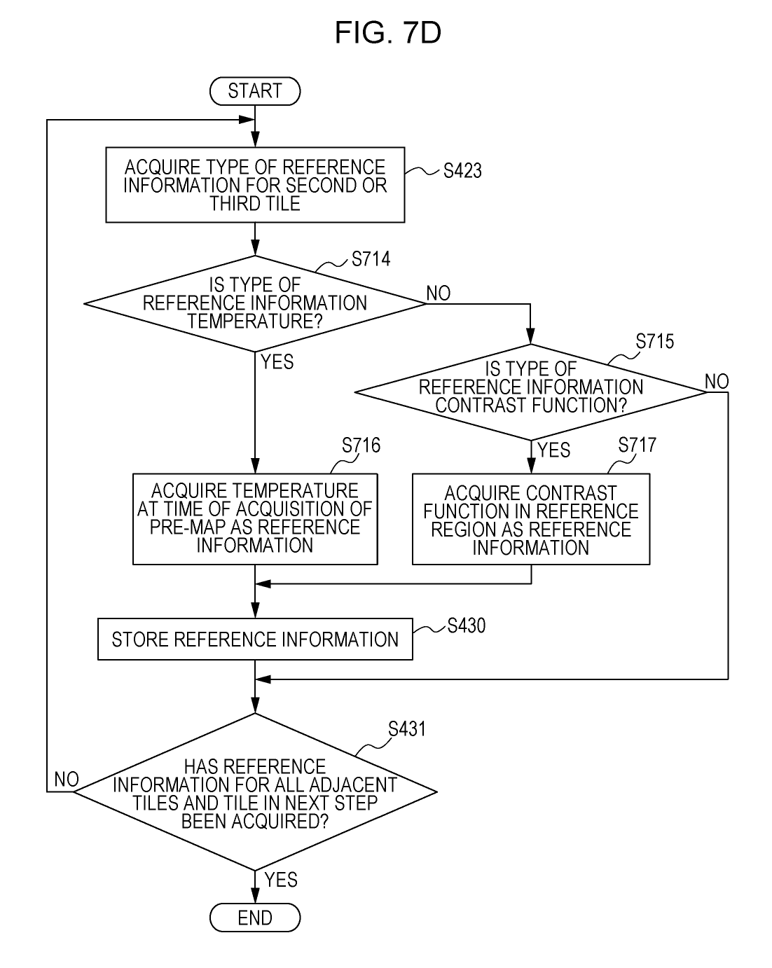

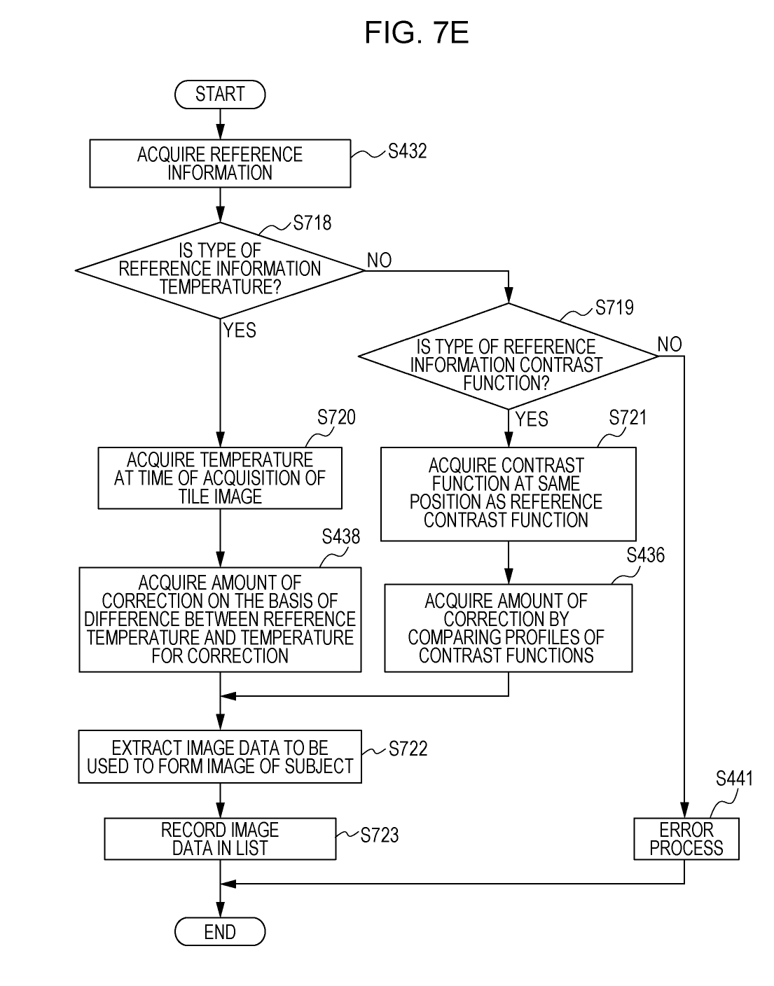

Specific processes will be described with reference to the flowcharts illustrated in FIGS. 7A to 7E. In step S701, the device 601 is initialized. Specifically, as illustrated in FIG. 7B, steps S409 to S411 described in the first embodiment are performed, and then the process proceeds to step S702. Steps S409 to S411 are similar to those in the first embodiment, and thus the description thereof is omitted.

In step S702, an image of the capturing range acquired in step S701 is captured by the image capturing unit 213 so as to acquire premap image data. At this time, the image capturing unit 213 captures images of a plurality of positions that are different imaging positions in the thickness direction of a specimen, that is, a plurality of positions different in the optical axis direction (Z axis) of the image formation optical unit 209, in a region having the same two-dimensional plane as the entire capturing range. The temperature measurement unit 210 measures a temperature of the device 601 at the time of acquisition of the premap image data, and records the measurement result in a header portion of the premap image data.

In step S703, the plurality of tiles acquired in step S701 are associated with a positional relationship in the two-dimensional plane direction in the premap image acquired in step S702.

In step S704, the image capturing unit 213 acquires tile images for the respective tiles set in step S701. A process of acquiring tile images will be described with reference to the flowchart illustrated in FIG. 7C.

In step S711, the image capturing unit 213 captures images of a plurality of positions different in the optical axis direction of the first tile, and thereby Z-stack image data is acquired. The temperature at the time of acquisition is recorded in a header portion of the Z-stack image data.

Subsequently, in step S712, the stage control unit 205 drives the stage 204 so as to move to the tile in the next step.

In step S713, the control unit 214 judges whether or not all the tile images in the capturing range determined in step S701 have been acquired. If all the tile images have been acquired, the process proceeds to step S705. If all the tile images have not been acquired, the process proceeds to step S711.

In step S705, reference information for each tile is selected. The process of selecting reference information is similar to step S402 according to the first embodiment. That is, the selection unit 217 selects, with reference to the image of the first tile, reference information for a second tile adjacent to the first tile and a tile whose image is to be captured next.

In the first embodiment, an image of the first tile acquired through capturing by the image capturing unit 213 is referred to. In this embodiment, reference information is selected using a region corresponding to the first tile in premap image data as an image of the first tile. Other than that, the process is similar to step S402 in the first embodiment, and thus a detailed description thereof is omitted.

In step S706, the reference information determined in step S705 is acquired from the premap image data. The process of acquiring reference information from the premap image data will be described with reference to the flowchart illustrated in FIG. 7D. The individual steps in this process are performed by the acquisition unit 218.

In step S423, the type of reference information is acquired. Step S423 is similar to that in the first embodiment, and thus the description thereof is omitted.

In step S714, it is judged whether or not the type of reference information acquired in step S423 is a temperature. If the type of reference information is a temperature, the process proceeds to step S716. If the type of reference information is not a temperature, the process proceeds to step S715.

In step S715, it is judged whether or not the type of reference information acquired in step S423 is a profile of a contrast function. If the type of reference information is a profile of a contrast function, the process proceeds to step S717. If the type of reference information is not a profile of a contrast function, the process proceeds to step S431.

In step S716, the temperature of the device 101 at the time of acquisition of the premap image data is acquired as reference information.

In step S717, a profile of a contrast function at the position corresponding to a reference region is calculated as reference information by using the premap image data.

In step S430, the acquired reference information is stored in the storage device 303, and the process proceeds to step S431. Steps S430 and S431 are similar to those in the first embodiment, and thus the description thereof is omitted. After step S706 has finished, the process proceeds to step S707.

In step S707, the acquisition unit 219 acquires an amount of drift correction on the basis of the reference information acquired in step S706. With use of the acquired amount of correction, image data is extracted from the Z-stack image data. The image data has been captured at the same relative positions as the relative positions of a surface conjugated with the light reception surface of the image capturing unit 213 in the image of the first tile and a subject. Here, image data at the same relative positions as the relative positions in the premap image data, instead of the relative positions in the image of the first tile, may be extracted. A drift correction process will be described with reference to the flowchart illustrated in FIG. 7E.

In step S432, the type of reference information is acquired. Step S432 is similar to that in the first embodiment, and thus the description thereof is omitted.

In step S718, it is judged whether or not the type of reference information acquired in step S432 is a temperature. If the type of reference information is a temperature, the process proceeds to step S720. If the type of reference information is not a temperature, the process proceeds to step S719.

In step S719, it is judged whether or not the type of reference information acquired in step S432 is a profile of a contrast function. If the type of reference information is a profile of a contrast function, the process proceeds to step S721. If the type of reference information is not a profile of a contrast, the process proceeds to step S441.

In step S720, the acquisition unit 219 acquires, from the header portion of the Z-stack image data, the temperature of the device 101 at the time of acquisition of the tile image.

In step S721, a profile of a contrast function is acquired in a reference region on tile image data at the position that substantially matches, on the XY plane of the specimen, the position at which a plurality of reference region images used for acquiring a profile of a reference contrast function have been acquired. The profile of the contrast function acquired here is hereinafter referred to as a contrast function for correction. The contrast function for correction is acquired by the acquisition unit 218 and is then transmitted to the acquisition unit 219. Alternatively, the contrast function for correction may be directly acquired by the acquisition unit 219.

In steps S436 and S438, the acquisition unit 219 acquires an amount of correction on the basis of the reference information acquired in steps S721 and S720. Steps S436, S438, and S441 are similar to those in the first embodiment, and thus the description thereof is omitted.

In step S722, the sub control unit 228 extracts the image data to be used for forming an image of the subject from the Z-stack image data on the basis of the amount of correction acquired in step S436 or S438. At this time, the sub control unit 228 extracts the image data of the first tile or the image data captured at the same relative positions as the relative positions at the time of acquisition of the premap image data. If there is not the image data in which the relative positions are the same, the sub control unit 228 extracts image data in which a difference in relative positions is the smallest.

In this embodiment, the sub control unit 228 as a processing unit extracts the image data to be used for forming an image of the subject. Alternatively, the computer 103 may extract the image data instead of the sub control unit 228. The processing unit that extracts an image is not limited to the sub control unit 228, and may be the computer 103.

In step S723, the image data extracted from the Z-stack image data in step S722 is recorded in a list.

In step S708, it is judged whether or not drift correction has been performed on all the tile images. If drift correction has been performed on all the tile images, the process proceeds to step S710. If drift correction has not been performed on all the tile images, the process proceeds to step S709.

In step S709, a target tile is changed. At this time, a target tile may be determined in accordance with the order in which tile images are acquired in step S704.

In step S710, color reproduction image data is generated in a process similar to that in step S407 according to the first embodiment. At this time, combining of pieces of image data by the processing unit 223 is performed on the basis of the information recorded in the list in step S723, and thereby a large size image data of the subject on which drift correction has been performed is generated.

In step S408, the color reproduction image data generated in step S710 is compressed by the processing unit 226, and is transmitted to the storage device 303. Step S408 is similar to that in the first embodiment, and thus the detailed description thereof is omitted.

As described above, in this embodiment, reference information to be used for drift correction is selected by referring to premap image data that has been acquired before acquisition of tile images. In a case where the reference information is an evaluation function, acquisition is performed using the premap image data. Accordingly, a drift that occurs during image capturing of individual tiles can be corrected using the premap image data. As a result, a large-size image data of the same focus position as that of the premap image data can be acquired, and an image with reduced artifacts can be efficiently acquired.

### Fourth Embodiment

The configuration of a WSI system according to a fourth embodiment is similar to that in the third embodiment, and thus the description thereof is omitted.

A brief description will be given of drift correction performed in the devices 601 and 602 according to this embodiment. In this embodiment, as in the third embodiment, images of a plurality of positions different in the optical axis direction of each tile are captured by the image capturing unit 213 so as to acquire Z-stack image data. An image to be used for generating large-size image data of the subject is extracted from the Z-stack image data, and thereby a drift is corrected. Note that premap image data is not acquired in this embodiment.

Further, in a case where there are a certain number or more of sequential tiles for which the temperature of the device 101 is set as reference information for drift correction, drift correction is skipped until drift correction based on a profile of a contrast function as reference information is performed (correction process skip function). An amount of drift correction for the skipped tiles is acquired in the following manner: among the amounts of correction previously acquired using a contrast function as reference information, a difference between the last amount of correction and the second last amount of correction is subjected to linear interpolation.

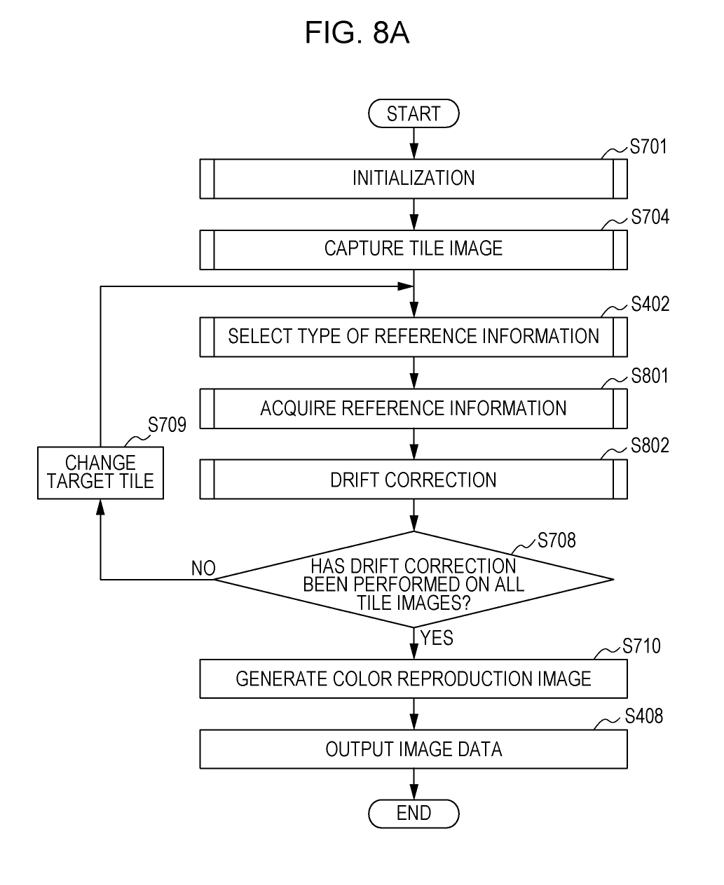

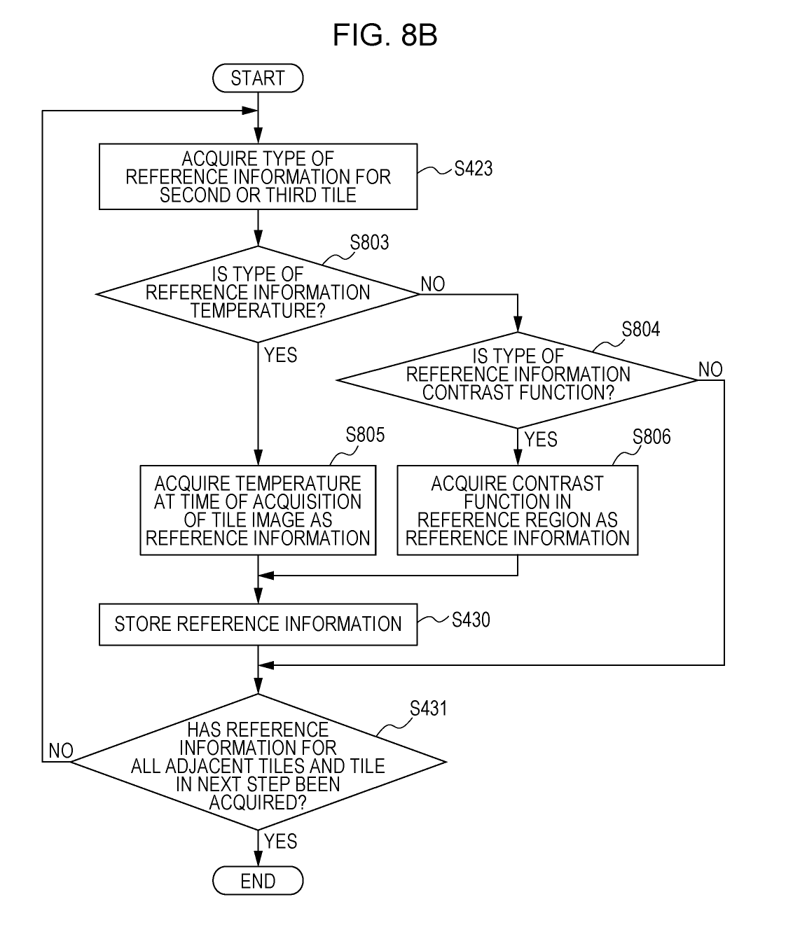

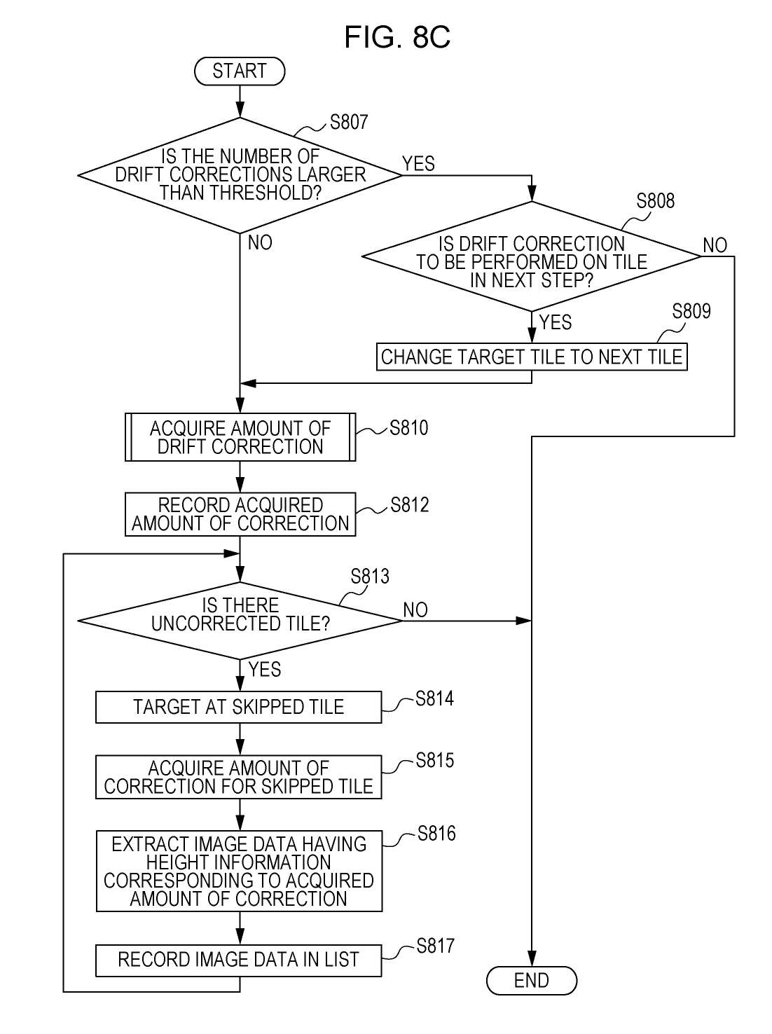

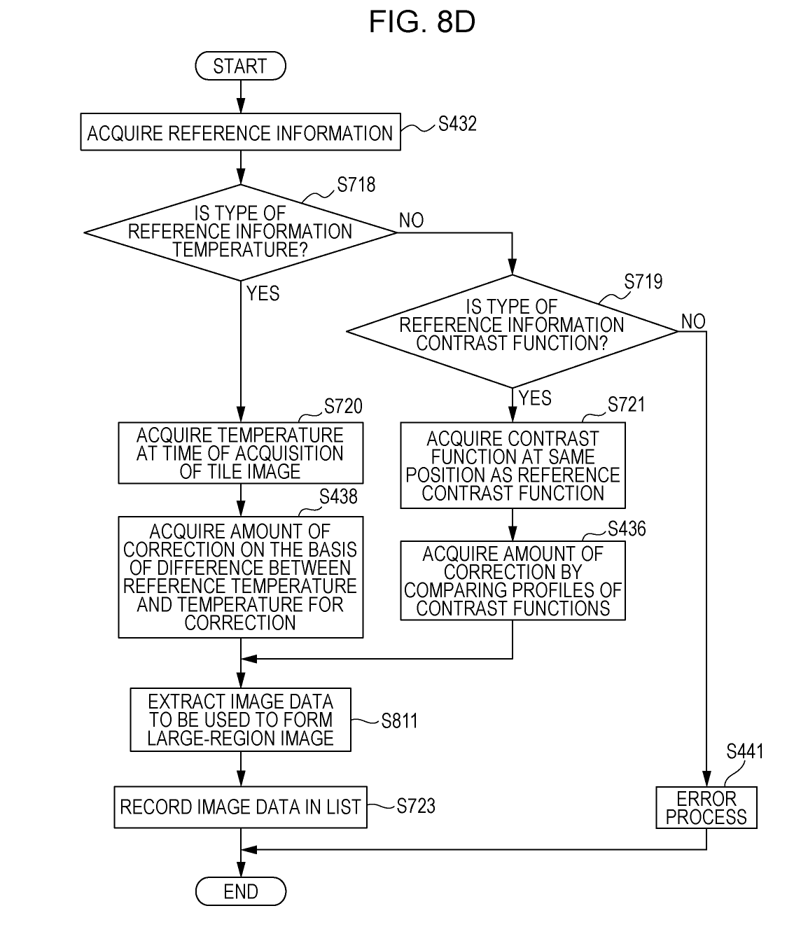

Detailed processes will be described with reference to the flowcharts illustrated in FIGS. 8A to 8D.

Step S701 is similar to that in the third embodiment except that a user inputs, as a threshold for implementing the correction process skip function, the number of sequential tile images for which a temperature is used as reference information as one of capturing conditions. Thus, the description thereof is omitted. The threshold may be automatically determined by the computer 103 on the basis of the capturing conditions, a history of usage, and so forth.

Steps S704 and S402 are similar to those in the third embodiment, and thus the description thereof is omitted.

In step S801, the reference information selected in step S402 is acquired. A process related to acquisition of the reference information is illustrated in FIG. 8B.

Step S423 is similar to that in the first embodiment, and thus the description thereof is omitted.

In step S803, the acquisition unit 218 judges whether or not the type of reference information selected in step S402 is a temperature. If the type of reference information is a temperature, the process proceeds to step S805. If the type of reference information is not a temperature, the process proceeds to step S804.

In step S804, the acquisition unit 218 judges whether or not the type of the reference information acquired in step S423 is a profile of a contrast function as an evaluation function. If the type of reference information is a contrast function, the process proceeds to step S806. If the type of reference information is not a contrast function, the process proceeds to step S431.

In step S805, the acquisition unit 218 acquires the temperature at the time of acquisition of a currently targeted tile image (hereinafter referred to as a reference temperature) from the header portion of the Z-stack image data, and regards it as reference information for drift correction.

In step S806, the acquisition unit 218 acquires a profile of a contrast function in a reference region (hereinafter referred to as a reference contrast function), and regards it as reference information for drift correction.

Steps S430 and S431 are similar to those in the first embodiment, and thus the description thereof is omitted. In step S802, drift correction is performed using the reference information acquired in step S801. A process related to drift correction is illustrated in FIG. 8C. This process is performed by the acquisition unit 219.

In step S807, it is judged whether or not the number of times drift correction has been sequentially performed using a temperature as reference information is larger than the threshold determined in step S701. If the number of times is larger than the threshold, the process proceeds to step S808. If the number of times is not larger than the threshold, the process proceeds to step S810.

In step S808, it is judged whether or not drift correction is to be performed on the tile in the next step of the currently targeted tile by using a profile of a contrast function as reference information. If a profile of a contrast function is used as reference information, the process proceeds to step S809. Otherwise, the process proceeds to step S708.

In step S809, the tile next to the first tile that is currently targeted is regarded as a target tile.

In step S810, the acquisition unit 219 acquires an amount of drift correction on the basis of the reference information acquired in step S801. A process related to acquisition of an amount of drift correction is illustrated in FIG. 8D.

In FIG. 8D, step S432 of acquiring the type of reference information, steps S436 and S438 of acquiring individual pieces of reference information, and step S441 of performing an error process are similar to those in the first embodiment, and thus the description thereof is omitted. Also, step S718 to S721 are similar to those in the third embodiment, and thus the description thereof is omitted.

In step S811, the sub control unit 228 extracts the image data to be used for forming a large-region image from the Z-stack image data on the basis of the amount of correction acquired by the acquisition unit 219 in step S436 or S438. At this time, the sub control unit 228 extracts, from the Z-stack image data, image data that has been captured at the same relative positions as the relative positions of a surface conjugated with the light reception surface of the image capturing unit 213 when the image of the tile in the first region used for acquiring reference information is captured and the subject. In a case where image data of the same relative positions does not exist, the sub control unit 228 extracts image data in which a difference in relative positions is the smallest. Alternatively, extraction of the image data may be performed by the computer 103.

In step S812, the amount of correction acquired in step S810 is recorded in the storage device 303.

In step S813, it is judged whether or not there is a tile for which correction has been skipped and has not been performed due to steps S807 and S808. If there is such a tile, the process proceeds to step S814. If there is not such a tile, the process proceeds to step S708.

In step S814, the tile for which correction has been skipped is regarded as a target.

In step S815, the acquisition unit 219 acquires, among the amounts of correction recorded in step S812, the amount of correction recorded last in time series and the amount of correction recorded immediately before the last amount of correction, performs linear interpolation on the difference therebetween, and thereby calculates the amount of correction for the tile image targeted in step S814.

In step S816, the sub control unit 228 extracts, from the Z-stack image data, image data having the height information corresponding to the amount of correction calculated in step S815. In a case where corresponding image data does not exist, the sub control unit 228 extracts image data having the height information that is the closest to the height corresponding to the amount of drift correction.

In step S817, the image data in the Z-stack image data acquired in step S816 is recorded in a list.

Steps S708 to S710 are similar to those in the third embodiment, and step S408 is similar to that in the first embodiment, and thus the description thereof is omitted.

As described above, according to this embodiment, drift correction is deferred in a case where the number of drift corrections that have been sequentially performed using a temperature as reference information is a certain number. For the tile image for which drift correction has been deferred, the amount of correction is determined using a result of drift correction that has been performed using a profile of a contrast function as reference information. Accordingly, accumulation of drift correction errors, which are caused by sequentially-performed drift corrections using a temperature as reference information, can be reduced. As a result, an image with reduced artifacts can be efficiently acquired. Further, the accuracy of drift correction can be increased.

### OTHER EMBODIMENTS

Additional embodiments can also be realized by a computer of a system or apparatus that reads out and executes computer executable instructions recorded on a storage medium (e.g., computer-readable storage medium) to perform the functions of one or more of the above-described embodiments, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

For example, in the above-described embodiments, the image processing device is incorporated into the computer as a dedicated board, but the image processing device may be constituted by software that executes a similar function in the computer. The configuration of the WSI system is not limited to that according to the above-described embodiments. For example, the device 102 may be incorporated into the device 101. Alternatively, a notebook PC in which the computer 103 and the device 104 are integrated together, or a device in which all the devices are integrated together may be used.

In the above-described embodiments, the Z-stack image data acquired by the device 601 is stored in the server located on the network 604. After that, a color reproduction image may be generated by the device 602 and the computer 603 by using the Z-stack image data in the server in the system.

In the first and second embodiments, drift correction is performed by changing the height of the stage. Alternatively, drift correction may be performed by moving the image sensor or the image formation optical unit 209.

A two-dimensional image sensor is used as the image sensor. Alternatively, a one-dimensional image sensor (line sensor) may be used. In this case, image data acquired through one scanning operation may correspond to a tile image in the above-described embodiments.

In the above-described embodiments, a contrast function is used as an evaluation function. Alternatively, an evaluation function used in an existing autofocus algorithm, such as a Tenenbaum Gradient method in which gradient vectors of individual pixels are used, and an entropy method in which an information amount of an image is used, may be used.

Reference information for each tile and a temperature of the microscope device at the time of acquisition of an image are recorded in a header portion of image data, but may be stored as separate files in the storage device or as link information on a network.

The above-described embodiments may be implemented in combination with one another. For example, in the first embodiment, the devices 101 and 102 may be connected to each other via a network as in the third embodiment. In the second embodiment, premap image data may be acquired and may be used for drift correction as in the third embodiment. Configurations that are obtained by appropriately combining various techniques according to the individual embodiments are also included in the scope of the present disclosure.

This application claims the benefit of Japanese Patent Application No. 2013-245900, filed Nov. 28, 2013, which is hereby incorporated by reference herein in its entirety.

What is claimed is:

1. An image acquisition device that acquires an image of a subject by capturing images of a plurality of regions of the subject, comprising:
an image capturing device including an image formation optical unit configured to form an image of the subject and an image capturing unit configured to capture an image of the subject;
a temperature measurement unit configured to measure a temperature of the image capturing device;
a selection unit configured to select the temperature or an evaluation function by referring to an image of a first region from among the plurality of regions, the temperature or the evaluation function being selected as reference information for a second region adjacent to the first region;
an information acquisition unit configured to acquire, as the reference information, the temperature or the evaluation function selected by the selection unit; and
a control unit configured to adjust relative positions, in an optical axis direction of the image formation optical unit, of a surface conjugated with a light reception surface of the image capturing unit and the subject in accordance with the reference information acquired by the information acquisition unit, and cause the image capturing unit to capture an image of the second region,
wherein the evaluation function is a function representing a relationship between (i) information about a plurality of overlapped-region images that are acquired by capturing images of a plurality of positions different in the optical axis direction in an overlapped region where the first region overlaps the second region, and (ii) the plurality of positions.

2. The image acquisition device according to claim 1, wherein the selection unit selects, as the reference information, the temperature or the evaluation function in accordance with whether a specimen in the subject exists in the overlapped region of the image of the first region.

3. The image acquisition device according to claim 1, wherein the control unit adjusts the relative positions so that the relative positions at a time when the image of the first region is captured are identical to the relative positions at a time when the image of the second region is captured.

4. The image acquisition device according to claim 1, wherein
the image capturing device includes a stage that moves while supporting the subject, and
the control unit adjusts the relative positions by moving the stage in the optical axis direction.

5. The image acquisition device according to claim 1, wherein the evaluation function is a function representing a relationship between contrast of the plurality of overlapped-region images and the plurality of positions.

6. The image acquisition device according to claim 1, wherein, in a case where a specimen in the subject exists in the overlapped region, the selection unit selects the evaluation function as the reference information.

7. The image acquisition device according to claim 1, wherein, in a case where a specimen in the subject does not exist in the overlapped region and where the image capturing unit captures the image of the second region immediately after capturing the image of the first region, the selection unit selects the temperature as the reference information.

8. The image acquisition device according to claim 1, wherein,
in a case where the image capturing unit captures an image of a third region that is not adjacent to the first region immediately after capturing the image of the first region and where reference information for the third region is not selected, the selection unit selects the temperature as the reference information for the third region,
in a case where the selection unit selects the temperature as the reference information for the third region, the information acquisition unit acquires the temperature, and
the control unit adjusts the relative positions in accordance with the temperature acquired by the information acquisition unit and causes the image capturing unit to capture an image of the third region.

9. The image acquisition device according to claim 1, wherein the selection unit refers to an image of a fourth region adjacent to the second region and, in a case where a specimen in the subject does not exist in an overlapped region where the second region overlaps the fourth region, the selection unit defers selecting of the reference information with reference to the image of the fourth region, and selects the reference information with reference to the image of the first region that is captured after the image of the fourth region.

10. An image acquisition device that acquires an image of a subject by capturing images of a plurality of regions of the subject, comprising:
an image capturing device including an image formation optical unit configured to form an image of the subject and an image capturing unit configured to capture an image of the subject;
a temperature measurement unit configured to measure a temperature of the image capturing device;
a selection unit configured to select the temperature or an evaluation function by referring to an image of a first region from among the plurality of regions, the temperature or the evaluation function being selected as reference information for a second region adjacent to the first region;
an information acquisition unit configured to acquire, as the reference information, the temperature or the evaluation function selected by the selection unit; and
a processing unit configured to extract an image of the second region to be used for forming the image of the subject from among a plurality of images of the second region that are acquired by capturing, with the image capturing unit, images of a plurality of positions different in an optical axis direction of the image formation optical unit in the second region in accordance with the reference information acquired by the information acquisition unit,
wherein the evaluation function is a function representing a relationship between (i) information about a plurality of overlapped-region images that are acquired by capturing images of a plurality of positions different in the optical axis direction in an overlapped region where the first region overlaps the second region, and (ii) the plurality of positions different in the optical axis direction in the overlapped region.

11. The image acquisition device according to claim 10, wherein the selection unit selects, as the reference information, the temperature or the evaluation function in accordance with whether a specimen in the subject exists in the overlapped region of the image of the first region.

12. The image acquisition device according to claim 10, wherein the processing unit extracts the image of the second region to be used for forming the image of the subject so that a difference between (i) relative positions of a surface conjugated with a light reception surface of the image capturing unit in the image of the first region to be used for forming the image of the subject and the subject and (ii) the relative positions in the image of the second region to be used for forming the image of the subject is minimized.

13. The image acquisition device according to claim 10, wherein the evaluation function is a function representing a relationship between contrast of the plurality of overlapped-region images and the plurality of positions.

14. The image acquisition device according to claim 10, wherein, in a case where a specimen in the subject exists in the overlapped region, the selection unit selects the evaluation function as the reference information.

15. The image acquisition device according to claim 10, wherein, in a case where a specimen in the subject does not exist in the overlapped region and where the image capturing unit captured the image of the second region immediately after capturing the image of the first region, the selection unit selects the temperature as the reference information.

16. The image acquisition device according to claim 10, wherein,
in a case where the image capturing unit captures an image of a third region that is not adjacent to the first region immediately after capturing the image of the first region and where a specimen in the subject does not exist in an overlapped region where the third region overlaps an adjacent region, the selection unit selects the temperature as reference information for the third region,
in a case where the selection unit selects the temperature as the reference information for the third region, the information acquisition unit acquires the temperature, and
the processing unit extracts the image of the second region to be used for forming the image of the subject from among the plurality of images of the second region in accordance with the temperature acquired by the information acquisition unit.

17. An image acquisition method for acquiring an image of a subject by capturing images of a plurality of regions of the subject by using an image capturing device including an image formation optical unit configured to form an image of the subject and an image capturing unit configured to capture an image of the subject, and a temperature measurement unit configured to measure a temperature of the image capturing device, the image acquisition method comprising:
a selection step of selecting the temperature or an evaluation function as reference information for a second region adjacent to a first region by referring to an image of the first region;
an information acquisition step of acquiring, as the reference information, the temperature or the evaluation function selected in the selection step;
a control step of adjusting relative positions, in an optical axis direction of the image formation optical unit, of a surface conjugated with a light reception surface of the image capturing unit and the subject in accordance with the reference information acquired in the information acquisition step; and
an image capturing step of capturing an image of the second region in a state where the relative positions have been adjusted,
wherein the evaluation function is a function representing a relationship between (i) information about a plurality of overlapped-region images that are acquired by capturing images of a plurality of positions different in the optical axis direction in an overlapped region where the first region overlaps the second region, and (ii) the plurality of positions.

18. A computer-readable storage medium that stores computer-executable instructions causing a computer to execute the individual steps of the image acquisition method according to claim 17.

19. An image acquisition method for acquiring an image of a subject by capturing images of a plurality of regions of the subject by using an image capturing device including an image formation optical unit configured to form an image of the subject and an image capturing unit configured to capture an image of the subject, and a temperature measurement unit configured to measure a temperature of the image capturing device, the image acquisition method comprising:
a selection step of selecting the temperature or an evaluation function as reference information for a second region adjacent to a first region by referring to an image of the first region;
an information acquisition step of acquiring, as the reference information, the temperature or the evaluation function selected in the selection step; and
a processing step of extracting an image of the second region to be used for forming the image of the subject from among a plurality of images of the second region that are acquired by capturing, with the image capturing unit, images of a plurality of positions different in an optical axis direction of the image formation optical unit in the second region in accordance with the reference information acquired in the information acquisition step,
wherein the evaluation function is a function representing a relationship between (i) information about a plurality of overlapped-region images that are acquired by capturing images of a plurality of positions different in the optical axis direction in an overlapped region where the first region overlaps the second region, and (ii) the plurality of positions different in the optical axis direction in the overlapped region.

20. A computer-readable storage medium that stores computer executable instructions causing a computer to execute the individual steps of the image acquisition method according to claim 19.
